(19) United States
(12) Patent Application Publication
(10) Pub. No.: US 2018/0007755 A1
(43) Pub. Date: Jan. 4, 2018

(54) LIGHT-SOURCE DRIVING APPARATUS AND LIGHT-SOURCE DRIVING METHOD

(71) Applicant: FUJITSU TEN LIMITED, Kobe-shi (JP)

(72) Inventor: Kazuaki MUROTA, Kobe-shi (JP)

(73) Assignee: FUJITSU TEN LIMITED, Kobe-shi (JP)

(21) Appl. No.: 15/602,689

(22) Filed: May 23, 2017

(30) Foreign Application Priority Data
Jun. 30, 2016 (JP) 2016-130854

(51) Int. Cl. H05B 33/08

(52) U.S. Cl. CPC H05B 33/0827; H05B 33/0851

(57) ABSTRACT

A light-source driving apparatus according to an embodiment includes a power supplying unit, a drive unit, and a controller. The power supplying unit generates a voltage by a step-up operation or a step-down operation to output the voltage to one or more light sources. The drive unit drives the one or more light sources. The controller causes the drive unit to drive the one or more light sources after a set time is elapsed from a start of the operation of the power supplying unit. The controller includes a change unit that changes a length of the set time and/or a rise rate of the voltage during the set time on the basis of states of one or more factors that affect a drop in the voltage.

### CROSS-REFERENCE TO RELATED APPLICATION

The present application claims priority to and incorporates by reference the entire contents of Japanese Patent Application No. 2016-130854 filed in Japan on Jun. 30, 2016.

### FIELD

The embodiment discussed herein is directed to a light-source driving apparatus and a light-source driving method.

### BACKGROUND

There is known a conventional light-source driving apparatus that includes a drive unit including a switching element to turn on and off this switching element by using a Pulse-Width-Modulation (PWM) control, and thus intermittently leads a current to a light source such as a Light-Emitting Diode (LED) to turn on and off this light source, thereby performing a dimmer control on the light source (see Japanese Laid-open Patent Publication No. 2011-216663).

The aforementioned light-source driving apparatus stops a step-down operation or a step-up operation performed by a power supplying unit during an interval in which the PWM control turns off the light source, and thus a voltage of a capacitor (for example, smoothing capacitor) provided on an output side of the power supplying unit fluctuates at a PWM period. This is because, while the capacitor is charged with a constant voltage during execution of the step-up operation or the step-down operation by the power supplying unit, a voltage charged to the capacitor gradually drops, caused by a leakage current, during a stop of the execution of the operation.

In a case where a ceramic capacitor is used as the capacitor provided on the output side of the power supplying unit, when the voltage of this capacitor fluctuates to vibrate the capacitor at the PWM period by a piezoelectric effect of ceramic, there exists a fear that an abnormal noise occurs in a case where this PWM frequency is within the human audible area.

### SUMMARY

According to an aspect of an embodiment, a light-source driving apparatus includes a power supplying unit, a drive unit, and a controller. The power supplying unit generates a voltage by a step-up operation or a step-down operation to output the voltage to one or more light sources. The drive unit drives the one or more light sources. The controller causes the drive unit to drive the one or more light sources after a set time is elapsed from a start of the operation of the power supplying unit. The controller includes a change unit that changes a length of the set time and/or a rise rate of the voltage during the set time based on states of one or more factors that affect a drop in the voltage.

### BRIEF DESCRIPTION OF DRAWINGS

A more complete appreciation of the disclosed technology and many of the attendant advantages thereof will be readily obtained as the same becomes better understood by reference to the following detailed description when considered in connection with the accompanying drawings, wherein:

FIG. 1A is a diagram illustrating a configuration example of a light-source driving apparatus according to an embodiment;

FIG. 1B is a diagram illustrating a light-source driving process to be executed by the light-source driving apparatus according to the embodiment;

FIG. 2A is a diagram illustrating a state of an output voltage when an off interval is the longest in a case where a set time is constant;

FIG. 2B is a diagram illustrating the state of the output voltage when the off interval is the shortest in a case where the set time is constant;

FIG. 3 is a diagram illustrating a first configuration example of the light-source driving apparatus illustrated in FIG. 1A;

FIG. 4A is a diagram illustrating a relation, of the light-source driving apparatus illustrated in FIG. 3, between PWM signals, an output voltage, and a delay PWM signal when an off time is the longest;

FIG. 4B is a diagram illustrating the relation, of the light-source driving apparatus illustrated in FIG. 3, between the PWM signals, the output voltage, and the delay PWM signal when the off time is the shortest;

FIG. 5 is a diagram illustrating a second configuration example of the light-source driving apparatus illustrated in FIG. 1A;

FIG. 6 is a diagram illustrating configuration examples of a change unit and a step-up controlling unit of the light-source driving apparatus illustrated in FIG. 5;

FIG. 7 is a diagram illustrating a relation, of the light-source driving apparatus illustrated in FIG. 5, between a PWM signal, a delay PWM signal, a selection signal, a control voltage, and a reference voltage to be input to a comparator;

FIG. 8A is a diagram illustrating a relation, of the light-source driving apparatus illustrated in FIG. 5, between the PWM signals, an output voltage, and the delay PWM signal when an off time is the longest;

FIG. 8B is a diagram illustrating the relation, of the light-source driving apparatus illustrated in FIG. 5, between the PWM signals, the output voltage, and the delay PWM signal when the off time is the shortest;

FIG. 9 is a diagram illustrating a third configuration example of the light-source driving apparatus illustrated in FIG. 1A;

FIG. 10 is a diagram illustrating configuration examples of a delay unit, a temperature detecting unit, and a current setting unit of the light-source driving apparatus illustrated in FIG. 9;

FIG. 11 is a diagram illustrating a fourth configuration example of the light-source driving apparatus illustrated in FIG. 1A;

FIG. 12 is a diagram illustrating configuration examples of a temperature detecting unit, a voltage setting unit, a selection controlling unit, and a step-up controlling unit of the light-source driving apparatus illustrated in FIG. 11;

FIG. 13 is a diagram illustrating a fifth configuration example of the light-source driving apparatus illustrated in FIG. 1A;

FIG. 14 is a diagram illustrating states of an output voltage and a Light-Emitting-Diode (LED) current when a length of a set time is constant;

FIG. 15 is a diagram illustrating configuration examples of a switch, a current source, a delay unit, a current setting unit, and a change unit of the light-source driving apparatus illustrated in FIG. 13;

FIG. 16A is a diagram illustrating a relation, of the current setting unit illustrated in FIG. 13, between PWM signals, an output voltage, and a delay PWM signal when the LED current is set to be minimum;

FIG. 16B is a diagram illustrating the relation, of the current setting unit illustrated in FIG. 13, between the PWM signals, the output voltage, and the delay PWM signal when the LED current is set to be maximum;

FIG. 17 is a diagram illustrating a sixth configuration example of the light-source driving apparatus illustrated in FIG. 1A;

FIG. 18 is a diagram illustrating configuration examples of a current setting unit, a voltage setting unit, a selection controlling unit, and a step-up controlling unit of the light-source driving apparatus illustrated in FIG. 17;

FIG. 19A is a diagram illustrating a relation, of the current setting unit illustrated in FIG. 18, between PWM signals, an output voltage, and a delay PWM signal when an LED current is set to be minimum;

FIG. 19B is a diagram illustrating the relation, of the current setting unit illustrated in FIG. 18, between the PWM signals, the output voltage, and the delay PWM signal when the LED current is set to be maximum;

FIG. 20 is a diagram illustrating a seventh configuration example of the light-source driving apparatus illustrated in FIG. 1A;

FIG. 21 is a diagram illustrating configuration examples of a change unit and a delay unit illustrated in FIG. 20;

FIG. 22 is a diagram illustrating an eighth configuration example of the light-source driving apparatus illustrated in FIG. 1A;

FIG. 23 is a diagram illustrating configuration examples of a change unit and a step-up controlling unit illustrated in FIG. 22;

FIG. 24 is a diagram illustrating a configuration example of a power supplying unit provided with a step-down circuit instead of a step-up circuit; and

FIG. 25 is a diagram illustrating a display apparatus including the light-source driving apparatus according to the embodiment.

### DESCRIPTION OF EMBODIMENT

Hereinafter, an embodiment of a light-source driving apparatus and a light-source driving method disclosed in the present application will be described in detail with reference to accompanying drawings. In addition, the disclosed technology is not limited to the embodiment described below.

### 1. Light-Source Driving Apparatus

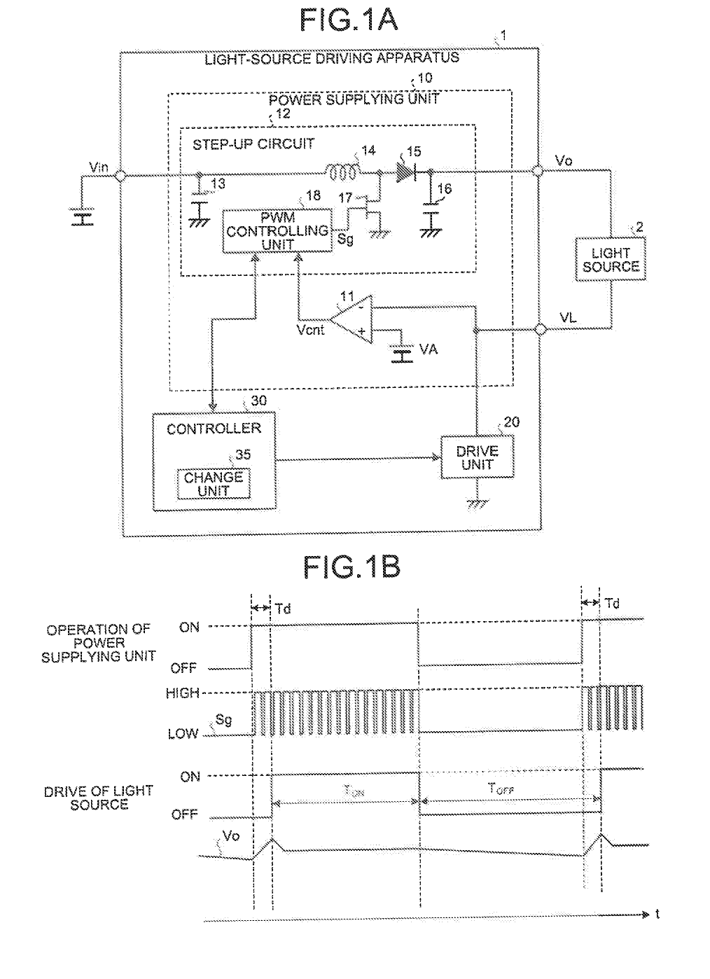

FIG. 1A is a diagram illustrating a configuration example of a light-source driving apparatus 1 according to the embodiment. FIG. 1B is a diagram illustrating a light-source driving process to be executed by the light-source driving apparatus 1 according to the embodiment.

As illustrated in FIG. 1A, the light-source driving apparatus 1 according to the embodiment includes a power supplying unit 10, a drive unit 20, and a controller 30, and supplies a current to a light source 2 by using a Pulse-Width-Modulation (PWM) control so as to perform a dimmer control of the light source. The light source 2 includes, for example, a Light-Emitting-Diode (LED) array, however, the light-source driving apparatus 1 may drive a light source other than an LED array. The LED array is constituted of a plurality of LEDs that are serially connected with one another.

The power supplying unit 10 includes an error amplifier 11 and a step-up circuit 12, and the power supplying unit 10 is connected with one end of the light source 2. The error amplifier 11 outputs a control voltage Vcnt according to a difference between a voltage VL at the other end of the light source 2 and a reference voltage VA.

The step-up circuit 12 performs a step-up operation on the basis of the control voltage Vcnt. As illustrated in FIG. 1A, this step-up circuit 12 includes, for example, capacitors 13 and 16, a coil 14, a diode 15, a switching element 17, and a PWM controlling unit 18. The PWM controlling unit 18 generates a PWM signal Sg on the basis of the control voltage Vcnt so as to control on and off of the switching element 17 by using this PWM signal Sg.

When the switching element 17 is turned on, energy is accumulated in the coil 14, and when the switching element 17 is turned off, the energy having been accumulated in the coil 14 is accumulated in the capacitor 16 through the diode 15. Thus, in the power supplying unit 10, an input voltage Vin is boosted so that the voltage VL at the other end of the light source 2 is the reference voltage VA and an output voltage Vo is generated, and this output voltage Vo is output to the one end of the light source 2 from the power supplying unit 10.

The drive unit 20 connects the other end of the light source 2 and the ground (ground potential) therebetween. This drive unit 20 includes a current source and a switch, when this switch is turned into a predetermined state (for example, “on”), the current source connects the other end of the light source 2 and the ground therebetween, and a current flows into the light source 2. When the current flows into the light source 2 in such a manner, the light source 2 is driven to light. The drive unit 20 may have a configuration that includes a switch, which is provided between the power supplying unit 10 and one end of the light source 2, and a current source, which connects the other end of the light source 2 and the ground therebetween. The drive unit 20 may have a configuration that includes a current source and a switch, and the drive unit 20 is provided between the power supplying unit 10 and the one end of the light source 2.

The controller 30 performs an on/off control on operations of the power supplying unit 10 and the drive unit 20 and supplies a current to the light source 2 by using a Pulse-Width-Modulation (PWM) control so as to perform a dimmer control of the light source 2.

As illustrated in FIG. 1B, a step-up operation of the power supplying unit 10 is stopped during an interval T_{OFF} (hereinafter, may be referred to as “off time T_{OFF}”) in which the light source 2 is turned off by the PWM control. Thus, a leakage current (for example, current directing in reverse direction of the diode 15 or current toward overvoltage detecting unit to be mentioned later) flows from the capacitor 16 provided on an output side of the power supplying unit 10, and thus the output voltage Vo gradually decreases.

Thus, when a leakage current flows from the capacitor 16 in the off time T_{OFF} (one example of non-driven time) and the output voltage Vo decreases, the output voltage Vo fluctuates in a PWM period. Moreover, when a voltage decrease in the output voltage Vo is large in the off time T_{OFF}, a time for boosting the output voltage Vo becomes long, and thus a time until the light source 2 lights is long.

Therefore, the controller 30 causes the drive unit 20 to drive the light source 2 after a set time Td from a start of a step-up operation of the power supplying unit 10. Thus, the output voltage Vo can be raised to a voltage or more, which can light the light source 2, by a timing when the controller 30 starts to drive the light source 2, and thus a lighting delay of the light source 2 can be suppressed.

Moreover, the controller 30 includes a change unit 35 that changes a length of the set time Td and a duty ratio of a PWM control during the set time Td on the basis of states of factors (hereinafter, may be referred to as “affecting factors”) that affect a drop in the output voltage Vo.

These affecting factors include, for example, an off-time affecting factor and an on-time affecting factor. The on-time affecting factor is a factor that affects a drop in the output voltage Vo during the off time T_{OFF}, and includes, for example, a length of the off time T_{OFF}, a temperature in the light-source driving apparatus 1, etc. The on-time affecting factor is an factor that affects a drop in the output voltage Vo during an interval T_{ON} (hereinafter, may be referred to as “on time T_{ON}”) in which a PWM control turns on the light source 2, and includes, for example, a value of a current flowing into the light source 2.

The controller 30 sets a length of the set time Td to be longer as a drop in the output voltage Vo by an effect of an off-time affecting factor is larger. For example, the controller 30 can set the length of the set time Td to be longer as the off time T_{OFF} is longer, and can set the length of the set time Td to be longer as the temperature in the light-source driving apparatus 1 is higher.

Moreover, the controller 30 can change a set duty ratio Ds that is a duty ratio (=PWM pulse width/one period) of the PWM signal Sg during the set time Td, in addition to or instead of the extension of the length of the set time Td.

This set duty ratio Ds is a duty ratio that is constant during the set time Td and does not depend on the control voltage Vcnt. The controller 30 can, for example, set the set duty ratio Ds to be larger as the off time T_{OFF} is longer, and can set the set duty ratio Ds to be larger as a temperature in the light-source driving apparatus 1 is higher.

Moreover, the controller 30 can set a length of the set time Td to be longer and set a value of the set duty ratio Ds to be larger as a fear is more probable that a drop in the output voltage Vo by an effect of an on-time affecting factor is large. For example, the controller 30 can set a length of the set time Td to be longer and set the set duty ratio Ds to be larger as a current flowing into the light source 2 is larger.

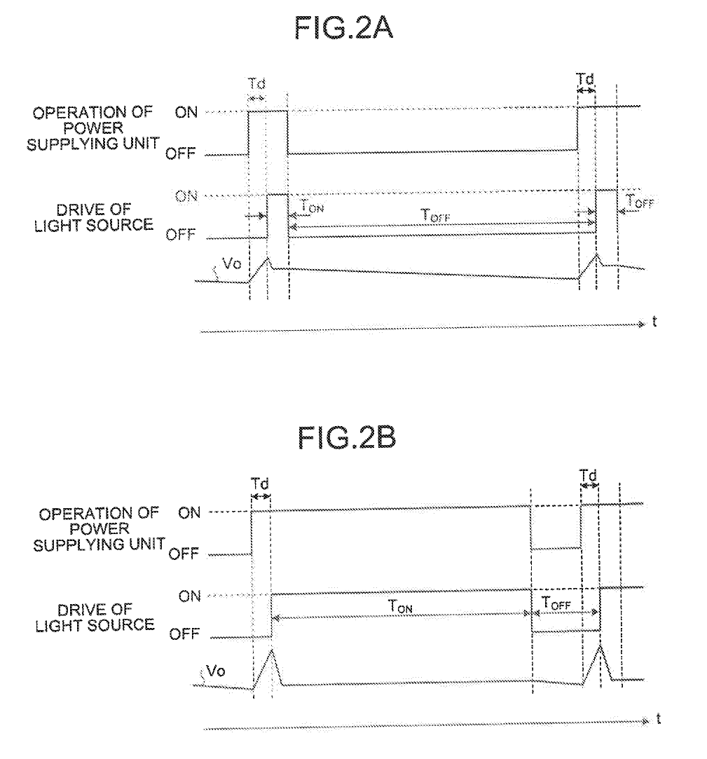

Herein, a case in which the set time Td is set to be constant will be explained. FIG. 2A is a diagram illustrating a state of the output voltage Vo when the off time T_{OFF} is the longest in a case where the set time Td is constant. FIG. 2B is a diagram illustrating the state of the output voltage Vo when the off time T_{OFF} is the shortest in a case where the set time Td is constant.

In a case where the set time Td is constant, the set time Td is needed to be set long so that the light source 2 can be driven even when the off time T_{OFF} is the longest (when light source 2 is driven with low brightness, for example, see FIG. 2A). Thus, when the off time T_{OFF} is short (light source 2 is driven with high brightness), as illustrated in FIG. 2B, the output voltage Vo rises more than needed, so that there exists a fear that a fluctuation in the output voltage Vo during a PWM period becomes large.

When a fluctuation in a PWM period is large, there exists a fear that an effect on the capacitor 16 or another circuit element may occur. For example, in a case where the capacitor 16 is a ceramic capacitor, when a fluctuation in the output voltage Vo is large in a PWM period, the capacitor 16 vibrates at a PWM period caused by a piezoelectric effect of ceramic, and there exists a fear that an abnormal noise occurs in a case where this PWM frequency is within the human audible area.

On the other hand, because the controller 30 of the light-source driving apparatus 1 changes a length of the set time Td and the set duty ratio Ds on the basis of states of factors that affect a drop in the output voltage Vo, a fluctuation in the output voltage Vo during a PWM period can be suppressed. Thus, for example, an abnormal noise caused by a vibration of the capacitor 16 can be prevented, and thus effects on the circuit elements can be suppressed.

In the aforementioned, the light-source driving apparatus 1 is configured so that the power supplying unit 10 includes the step-up circuit 12, however, the light-source driving apparatus 1 may be configured so that the power supplying unit 10 includes a step-down circuit instead of the step-up circuit 12.

Hereinafter, for the convenience of explanation, configuration examples, which execute processes corresponding to the respective on-time and off-time affecting factors, of the light-source driving apparatus 1 illustrated in FIG. 1A are divided into first to eighth configuration examples to be explained. As described hereinafter, a configuration may be employed that combines and executes the processes corresponding to all or two or more of the on-time and off-time affecting factors.

Hereinafter, for avoiding duplicated explanations, the configurations and the operations having been explained with reference to FIGS. 1A and 1B will be appropriately omitted. Moreover, hereinafter, an interval from a timing when a PWM signal Sp changes into High level to a timing when a delay PWM signal Spd changes into High level may be referred to as “delay time TD”.

### 2. First Configuration Example

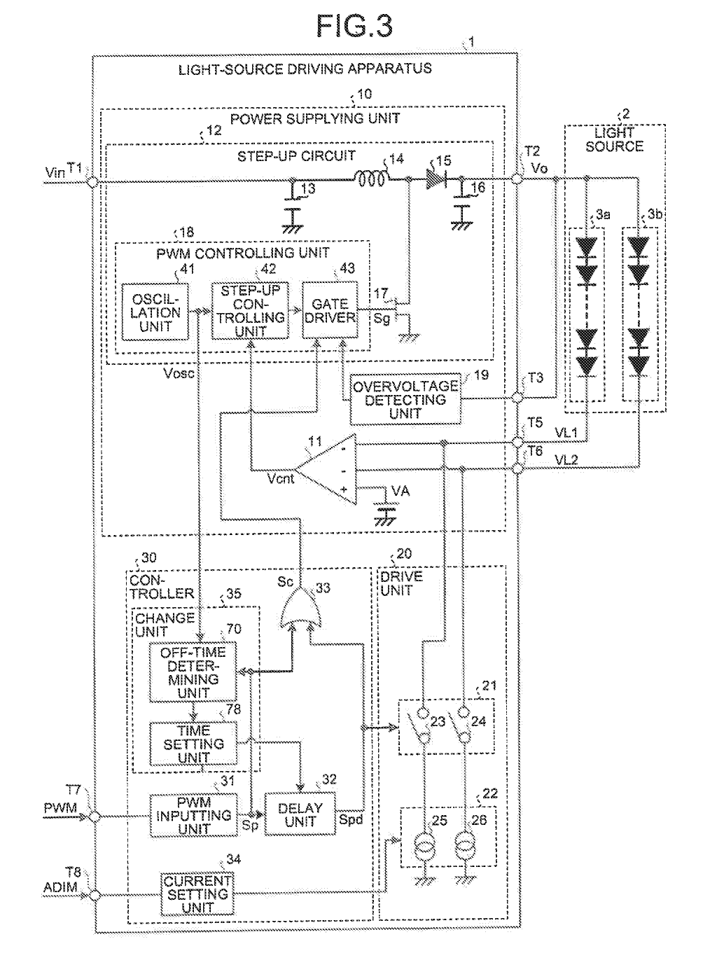

FIG. 3 is a diagram illustrating a first configuration example of the light-source driving apparatus 1 illustrated in FIG. 1A. The light-source driving apparatus 1 illustrated in FIG. 3 includes the aforementioned power supplying unit 10, the drive unit 20, and the controller 30 so as to be able to drive LED arrays 3a and 3b (hereinafter, may be collectively referred to as “LED array 3”) as the light source 2.

This light-source driving apparatus 1 includes a plurality of terminals such as a voltage inputting terminal T1, a voltage outputting terminal T2, an overvoltage detecting terminal T3, a first driving terminal T5, a second driving terminal T6, a PWM dimmer terminal T7, and a DC-dimming terminal T8. One end of the LED array 3a is connected with the voltage outputting terminal T2 and the other end thereof is connected with the first driving terminal T5. One end of the LED array 3b is connected with the voltage outputting terminal T2 and the other end thereof is connected with the second driving terminal T6.

The power supplying unit 10 includes the error amplifier 11, the step-up circuit 12, and an overvoltage detecting unit 19. The error amplifier 11 is connected with the other ends of the LED arrays 3a and 3b through the first driving terminal T5 and the second driving terminal T6. This error amplifier 11 generates the control voltage Vcnt, which controls a current flowing into the light source 2, so that a voltage (hereinafter, may be referred to as “voltage VLmin”) on a downstream side of the LED array 3, which has the lowest voltage value of voltages VL1 and VL2 at the respective other ends of the LED arrays 3a and 3b, is the reference voltage VA.

As described above, the step-up circuit 12 includes the capacitors 13 and 16, the coil 14, the diode 15, the switching element 17, and the PWM controlling unit 18. The capacitor 13 connects the voltage inputting terminal T1 and the ground therebetween. The coil 14 and the diode 15, which are serially connected, connect the voltage inputting terminal T1 and the voltage outputting terminal T2 therebetween.

The capacitor 16 connects the voltage outputting terminal T2 and the ground therebetween. The switching element 17 connects the ground and a connecting point of the coil 14 and the diode 15 therebetween. This switching element 17 includes, for example, a Metal-Oxide-Semiconductor Field-Effect Transistor (MOSFET).

The PWM controlling unit 18 includes an oscillation unit 41, a step-up controlling unit 42, and a gate driver 43. The oscillation unit 41 generates and outputs a carrier-wave voltage Vosc. A waveform of the carrier-wave voltage Vosc is that of, for example, a triangle wave or a sawtooth wave.

The step-up controlling unit 42 generates a PWM signal Sg1 on the basis of a compared result between the carrier-wave voltage Vosc and the control voltage Vcnt. This PWM signal Sg1 is Low level when the control voltage Vcnt is higher than the carrier-wave voltage Vosc, and High level when the control voltage Vcnt is lower than the carrier-wave voltage Vosc.

The gate driver 43 performs voltage amplification on the PWM signal Sg1 to generate the PWM signal Sg, and outputs this PWM signal Sg to a control terminal (for example, gate) of the switching element 17. On/off control is performed on the switching element 17 by this PWM signal Sg, and the output voltage Vo is adjusted so that a deviation from the reference voltage VA of the voltage VLmin is zero or reduced.

When a voltage (in example illustrated in FIG. 3, output voltage Vo) input to the overvoltage detecting terminal T3 is equal to or more than a set voltage Vref, the overvoltage detecting unit 19 outputs a signal of High level, and otherwise outputs a signal of Low level. The gate driver 43 stops when a signal of High level is output from the overvoltage detecting unit 19.

The drive unit 20 includes a switching unit 21 and a constant current unit 22. The switching unit 21 includes switches 23 and 24. The constant current unit 22 includes current sources 25 and 26. The switch 23 and the current source 25, which are serially connected with each other, connect the first driving terminal T5 and the ground therebetween. When this switch 23 is turned on, the LED array 3a can be lighted.

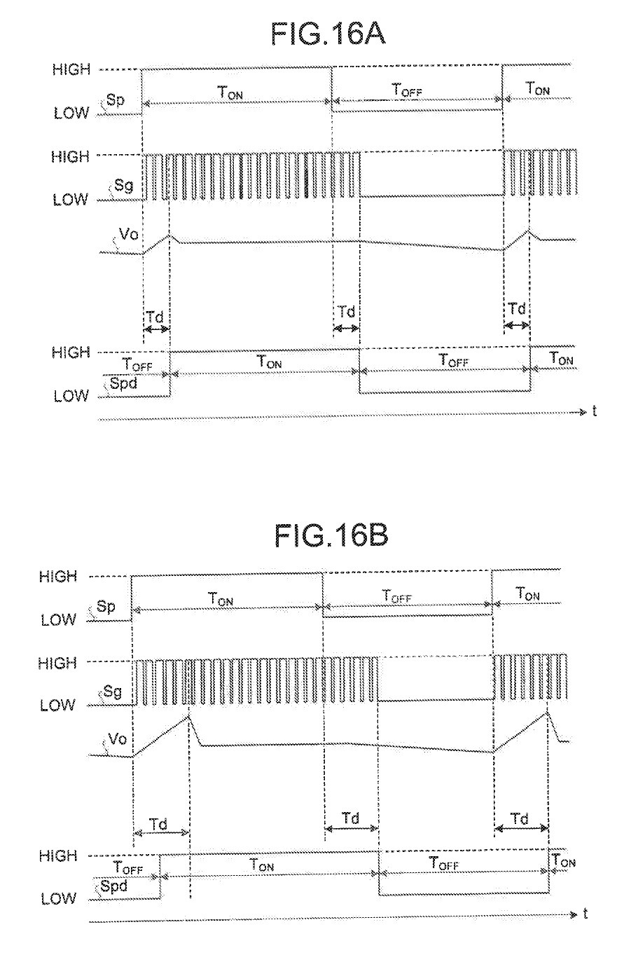

The switch 24 and the current source 26, which are serially connected, connect the second driving terminal T6 and the ground therebetween. When this switch 24 is turned on, the LED array 3b can be lighted. As described hereinafter, the drive unit 20 may have a configuration that turns off the switches 23 and 24 to light the LED arrays 3a and 3b (see FIG. 15).

The controller 30 includes a PWM inputting unit 31, a delay unit 32, a power-supply controlling unit 33, a current setting unit 34, and the change unit 35. This controller 30 controls a boosting interval of the power supplying unit 10 and a driving interval of the LED arrays 3a and 3b on the basis of a PWM controlling signal input to the PWM dimmer terminal T7 and an ADIM controlling signal input to the DC-dimming terminal T8.

The PWM inputting unit 31 generates the PWM signal Sp on the basis of the PWM controlling signal input to the PWM dimmer terminal T7. The delay unit 32 generates the delay PWM signal Spd obtained by delaying the PWM signal Sp by the set time Td, and outputs the delay PWM signal Spd to the switching unit 21. When this delay PWM signal Spd is High level, the switches 23 and 24 are turned on, when this delay PWM signal Spd is Low level, the switches 23 and 24 are turned off.

In a case where the switches 23 and 24 have such a configuration that is illustrated in FIG. 15, the switches 23 and 24 are turned off when the delay PWM signal Spd is High level, and the switches 23 and 24 are turned on when the delay PWM signal Spd is Low level.

The power-supply controlling unit 33 generates a step-up controlling signal Sc on the basis of the PWM signal Sp and the delay PWM signal Spd. The step-up controlling signal Sc is generated to be High level when at least one of the PWM signal Sp and the delay PWM signal Spd is High level. The power-supply controlling unit 33 is constituted of, for example, a logical OR circuit that performs a logical OR operation. When a signal of Low level is output from the power-supply controlling unit 33, the gate driver 43 stops outputting the PWM signal Sg, and when a signal of High level is output from the power-supply controlling unit 33, the gate driver 43 outputs the PWM signal Sg.

The current setting unit 34 adjusts current values of the current sources 25 and 26 on the basis of an ADIM controlling signal. Thus, values of currents are adjusted that flow into the respective LED arrays 3a and 3b when the switches 23 and 24 are on.

The change unit 35 sets the set time Td to be longer as an interval in which the PWM signal Sp is Low level, namely the off time T_{OFF}, is longer. This change unit 35 includes an off-time determining unit 70 and a time setting unit 78.

The off-time determining unit 70 counts an interval in which the PWM signal Sp is Low level to determine the off time T_{OFF} by using, as a clock signal, the carrier-wave voltage Vosc output from the oscillation unit 41, and informs the time setting unit 78 of this determination result. The off-time determining unit 70 may have a configuration that counts the off time T_{OFF} by using, as a clock signal, a signal different from the carrier-wave voltage Vosc.

The time setting unit 78 sets the set time Td according to the off time T_{OFF}, which is determined by the off-time determining unit 70, for the delay unit 32. This time setting unit 78 sets, for the delay unit 32, the longer set time Td as the off time T_{OFF} is longer.

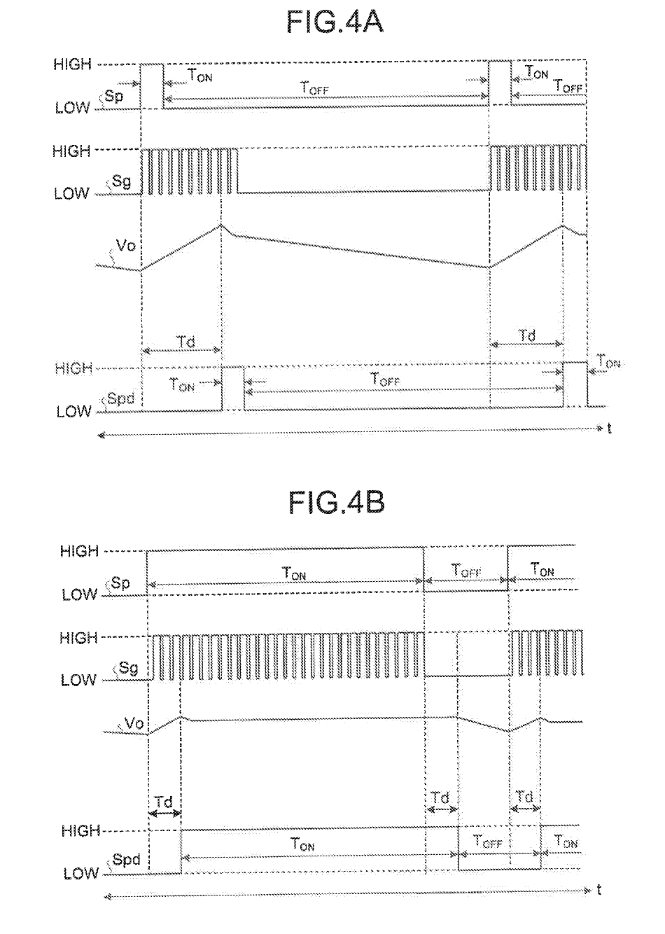

FIG. 4A is a diagram illustrating a relation, of the light-source driving apparatus 1 illustrated in FIG. 3, between the PWM signals Sp and Sg, the output voltage Vo, and the delay PWM signal Spd when the off time T_{OFF} is the longest. FIG. 4B is a diagram illustrating the relation, of the light-source driving apparatus 1 illustrated in FIG. 3, between the PWM signals Sp and Sg, the output voltage Vo, and the delay PWM signal Spd when the off time T_{OFF} is the shortest. The PWM signal Sg illustrated in FIGS. 4A and 4B indicates a state as to whether or not the gate driver 43 outputs the PWM signal Sg, and a change in a duty ratio thereof is not illustrated.

As illustrated in FIG. 4A, when the off time T_{OFF} is long, the change unit 35 sets the set time Td to be long. When the off time T_{OFF} is the longest, a dropped amount of the output voltage Vo is large and a time until when the voltage can drive the light source 2 is long, however, the change unit 35 sets the set time Td to be long. Thus, the output voltage Vo can be raised to a voltage enough to drive the light source 2 by a start timing of the on time T_{ON}, and thus a minimum lighting time of the light source 2 can be shortened.

On the other hand, as illustrated in FIG. 4B, when the off time T_{OFF} is short, the change unit 35 sets the set time Td to be short. When the off time T_{OFF} is short, a dropped amount of the output voltage Vo is small and a time until when the voltage can drive the light source 2 is short, however, the change unit 35 sets the set time Td to be short, and thus it is suppressed that the output voltage Vo is raised to more than needed.

Thus, even when the off time T_{OFF} is changed to change the brightness of the light source 2, a fluctuation in the output voltage Vo during a PWM period can be suppressed. Therefore, an abnormal noise caused by the vibration of the capacitor 16 can be prevented. Moreover, the set time Td is set to be short when the off time T_{OFF} is short, and thus a maximum lighting time of the light source 2 can be long.

The change unit 35 changes the set time Td on the basis of the off time T_{OFF}, because the off time T_{OFF} is in a proportional relation with a dropped amount of the output voltage Vo and the off time T_{OFF} is not affected by an on/off period (PWM period) of the PWM signal Sp, however, is not limited thereto. For example, when an on/off period (PWM period) of the PWM signal Sp is fixed, the delay unit 32 and the change unit 35 may have configurations that shorten the set time Td more as the on time T_{ON} is longer.

### 3. Second Configuration Example

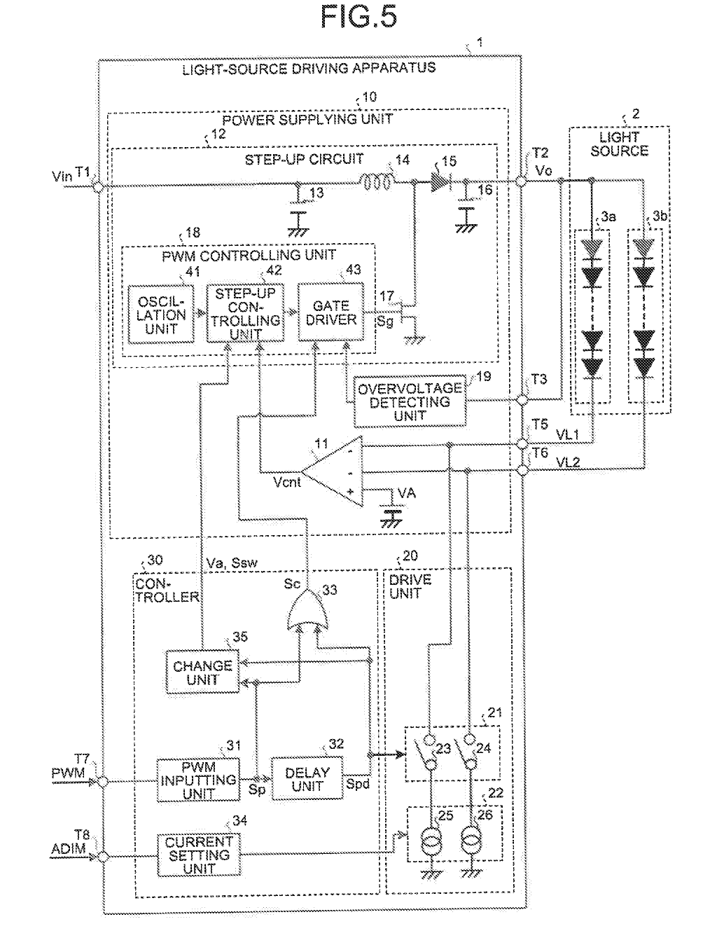

FIG. 5 is a diagram illustrating a second configuration example of the light-source driving apparatus 1 illustrated in FIG. 1A. The second configuration example of the light-source driving apparatus 1 differs from the first configuration example of the light-source driving apparatus 1 in that a rise rate of the output voltage Vo during the delay time TD, instead of a length of the set time Td (delay time TD), is changed. Hereinafter, points that differ from the first configuration example of the light-source driving apparatus 1 will be mainly explained, and explanation of other points will be appropriately omitted.

The controller 30 of the light-source driving apparatus 1 illustrated in FIG. 5 includes the change unit 35 that changes a rise rate of the output voltage Vo during the delay time TD in accordance with the off time T_{OFF}. This change unit 35 generates a control voltage Va according to a length of the off time T_{OFF}, and outputs this control voltage Va to the step-up controlling unit 42. The change unit 35 performs a logical multiplication computation on the PWM signal Sp and the delay PWM signal Spd so as to generate a selection signal Ssw that is High level during the delay time TD, and outputs this selection signal Ssw to the step-up controlling unit 42.

The step-up controlling unit 42 changes, on the basis of the selection signal Ssw, a control voltage to be used during the delay time TD from the control voltage Vcnt into the control voltage Va, and generates the PWM signal Sg on the basis of this control voltage Va and the carrier-wave voltage Vosc. Thus, a duty ratio of the PWM signal Sg is the set duty ratio Ds according to the off time T_{OFF} during the delay time TD, and a step-up operation is performed with this set duty ratio Ds. Therefore, the rise rate of the output voltage Vo during the delay time TD is changed in accordance with the off time T_{OFF}.

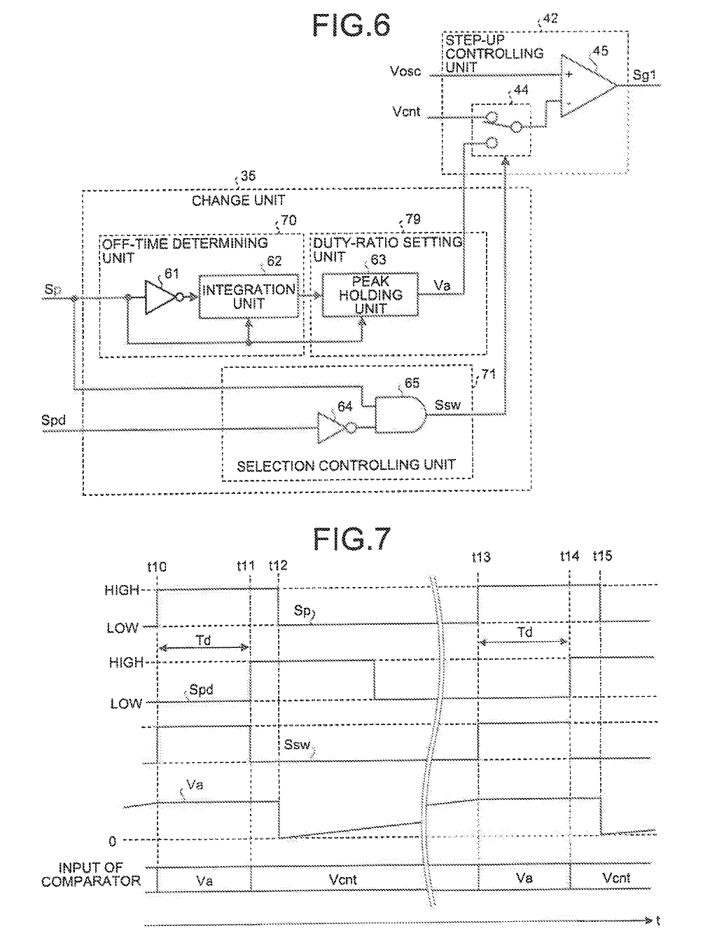

FIG. 6 is a diagram illustrating configuration examples of the change unit 35 and the step-up controlling unit 42 of the light-source driving apparatus 1 illustrated in FIG. 5. FIG. 7 is a diagram illustrating a relation, of the light-source driving apparatus 1 illustrated in FIG. 5, between the PWM signal Sp, the delay PWM signal Spd, the selection signal Ssw, the control voltage Va, and a reference voltage to be input to a comparator 45.

As illustrated in FIG. 6, the change unit 35 includes the off-time determining unit 70, a selection controlling unit 71, and a duty-ratio setting unit 79. The off-time determining unit 70 includes an inverter 61 and an integration unit 62. The inverter 61 inverts the PWM signal Sp. The integration unit 62 samples and integrates inverted values of the PWM signal Sp on the basis of a predetermined clock signal (for example, carrier-wave voltage Vosc or another clock signal). An integration result obtained by this integration unit 62 corresponds to a count value of the off time T_{OFF}.

The duty-ratio setting unit 79 includes a peak holding unit 63. As illustrated in FIG. 7, when the PWM signal Sp is Low level, the peak holding unit 63 outputs the control voltage Va according to an integration result of the integration unit 62 as it is, when the PWM signal Sp is turned into High level, the peak holding unit 63 holds a peak value of the integration result of the integration unit 62, and outputs the control voltage Va according to this peak value.

The peak value of the integration result of the integration unit 62 is a value that is proportional to the off time T_{OFF}, and thus the control voltage Va is also proportional to the off time T_{OFF}. Thus, the set duty ratio Ds of the PWM signal Sg to be generated on the basis of a comparison between the control voltage Va and the reference voltage VA is also proportional to the off time T_{OFF}. Let one period of the PWM signal Sg be “Tp”, and a time of High level of the one period of the PWM signal Sg be “To”, the set duty ratio Ds is indicated by “Ds=To/Tp”.

The selection controlling unit 71 includes an inverter 64 and a logical multiplication computing unit 65. The inverter 64 inverts the delay PWM signal Spd, and the logical multiplication computing unit 65 computes a logical multiplication between an inverted value of the delay PWM signal Spd and the PWM signal Sp and outputs the computation result as the selection signal Ssw. Thus, as illustrated in FIG. 7, in the delay time TD that is the set time Td during an interval between time points t10 and t11 or an interval between time points t13 and t14, the selection controlling unit 71 outputs the selection signal Ssw indicating High level.

The step-up controlling unit 42 includes a selection switch 44 and the comparator 45. The selection switch 44 selects one of the control voltage Vcnt and the control voltage Va on the basis of the selection signal Ssw, and outputs the selected one to the comparator 45. The comparator 45 compares a control voltage output from the selection switch 44 with the carrier-wave voltage Vosc to generate the PWM signal Sg1, and outputs the PWM signal Sg1 to the gate driver 43.

When the selection signal Ssw is Low level, as illustrated in FIG. 7, the selection switch 44 outputs the control voltage Vcnt to the comparator 45, the comparator 45 compares the control voltage Vcnt with the carrier-wave voltage Vosc to generate the PWM signal Sg1 according to the control voltage Vcnt and outputs the control voltage Vcnt to the gate driver 43.

On the other hand, when the selection signal Ssw is High level, as illustrated in FIG. 7, the selection switch 44 outputs the control voltage Va to the comparator 45, the comparator 45 compares the control voltage Va with the carrier-wave voltage Vosc to generate the PWM signal Sg1 having the set duty ratio Ds and outputs the PWM signal Sg1 to the gate driver 43.

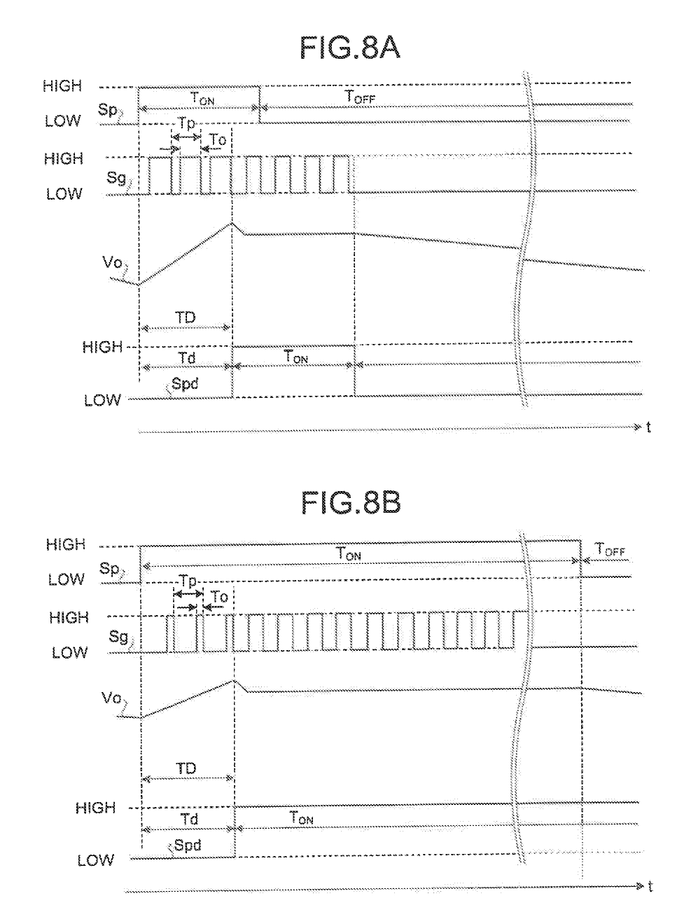

FIG. 8A is a diagram illustrating a relation, of the light-source driving apparatus 1 illustrated in FIG. 5, between the PWM signals Sp and Sg, the output voltage Vo, and the delay PWM signal Spd when the off time T_{OFF} is the longest. FIG. 8B is a diagram illustrating the relation, of the light-source driving apparatus 1 illustrated in FIG. 5, between the PWM signals Sp and Sg, the output voltage Vo, and the delay PWM signal Spd when the off time T_{OFF} is the shortest.

As illustrated in FIG. 8A, when the off time T_{OFF} is long, the change unit 35 sets the set duty ratio Ds to be large during the delay time TD. When the off time T_{OFF} is the largest, a dropped amount of the output voltage Vo is large and a time until when the voltage can drive the light source 2 is long, whereas the change unit 35 sets the set duty ratio Ds to be large. Thus, a rise rate of the output voltage Vo can be set to be high, and thus a minimum lighting time can be shortened.

On the other hand, as illustrated in FIG. 8B, when the off time T_{OFF} is short, the change unit 35 sets the set duty ratio Ds to be short during the delay time TD. When the off time T_{OFF} is short, a dropped amount of the output voltage Vo is small and a time until when the voltage can drive the light source 2 is short, whereas the change unit 35 sets the set duty ratio Ds to be small.

When the set duty ratio Ds is small, because a rise rate of the output voltage Vo is low, it is suppressed that the output voltage Vo is raised to more than needed. Thus, even when the off time T_{OFF} is changed to change the brightness of the light source 2, a fluctuation in the output voltage Vo during a PWM period can be suppressed and, for example, an abnormal noise caused by vibration of the capacitor 16 can be prevented.

### 4. Third Configuration Example

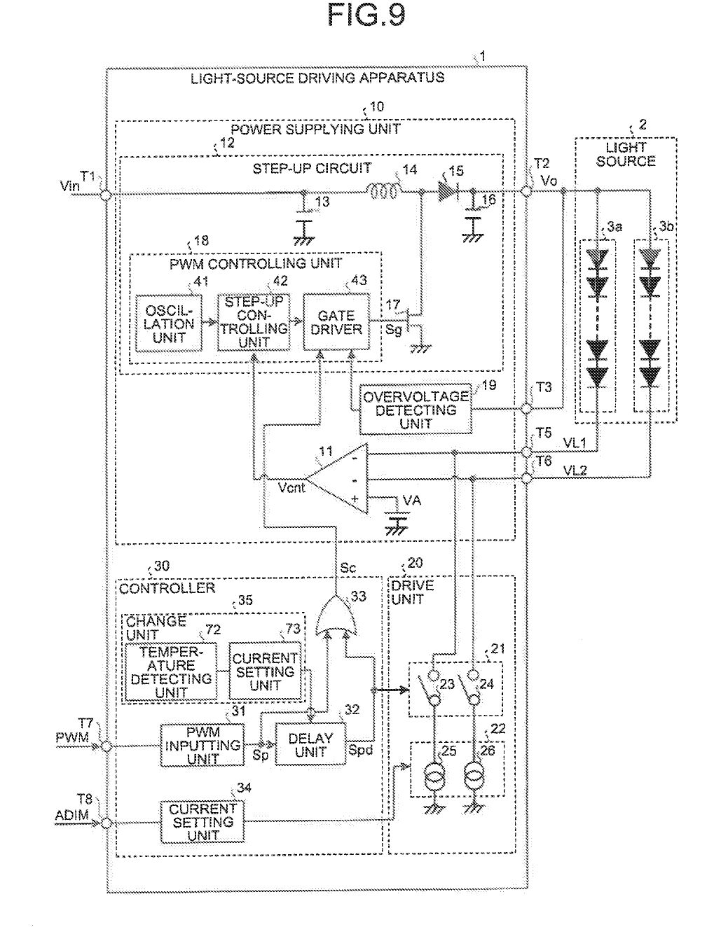

FIG. 9 is a diagram illustrating a third configuration example of the light-source driving apparatus 1 illustrated in FIG. 1. The third configuration example of the light-source driving apparatus 1 differs from the first configuration example of the light-source driving apparatus 1 in that a length of the set time Td is changed in accordance with, instead of the off time T_{OFF}, a temperature in the light-source driving apparatus 1. Hereinafter, points that differ from the first configuration example of the light-source driving apparatus 1 will be mainly explained, and explanation of other points will be appropriately omitted.

The controller 30 of the light-source driving apparatus 1 illustrated in FIG. 9 includes the change unit 35 that detects a temperature To (hereinafter, may be referred to as “internal temperature To”) in the light-source driving apparatus 1 and changes a length of the set time Td in accordance with the detected internal temperature To. This change unit 35 includes a temperature detecting unit 72 and a current setting unit 73.

The temperature detecting unit 72 outputs a voltage according to the internal temperature To. The internal temperature To is, for example, a peripheral temperature of an element (for example, diode 15 or capacitor 16) that affects decrease in the output voltage Vo or a temperature of this element.

The current setting unit 73 outputs, to the delay unit 32, a current according to a detection result of the internal temperature To obtained by the temperature detecting unit 72. The delay unit 32 changes the set time Td in accordance with a value of a current from the change unit 35, and outputs the delay PWM signal Spd obtained by delaying the PWM signal Sp by the changed set time Td.

Factors in decrease in the output voltage Vo during the off time T_{OFF} include an inverse-direction leakage current of the diode 15 in addition to a current flowing into the overvoltage detecting unit 19. The inverse-direction leakage current of the diode 15 increases as a temperature is higher. Thus, the internal temperature To affects a drop in the output voltage Vo during the off time T_{OFF}.

The light-source driving apparatus 1 illustrated in FIG. 9 sets the set time Td to be longer as the internal temperature To is higher, and thus the set time Td is longer as a drop in the output voltage Vo is larger. Thus, the set time Td according to a dropped amount of the output voltage Vo during the off time T_{OFF} is set, and thus a minimum lighting time can be shortened.

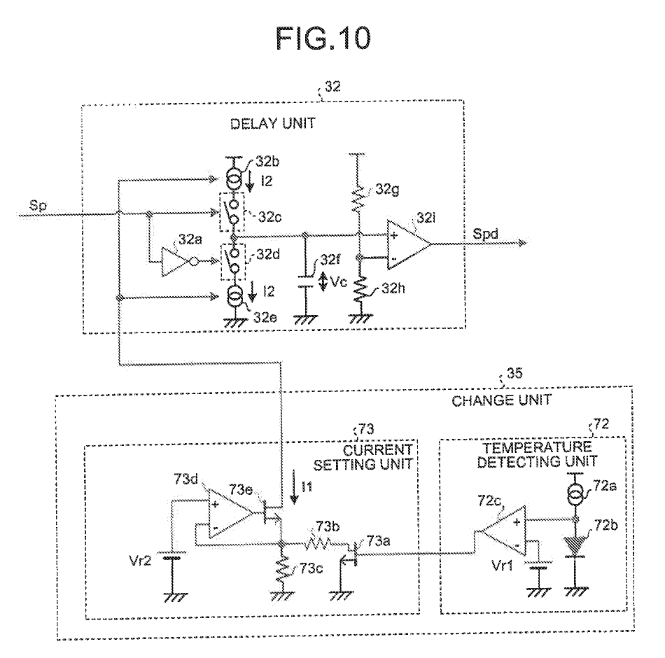

FIG. 10 is a diagram illustrating configuration examples of the delay unit 32, the temperature detecting unit 72, and the current setting unit 73 of the light-source driving apparatus 1 illustrated in FIG. 9. As illustrated in FIG. 10, the temperature detecting unit 72 includes a current source 72a, a diode 72b, and a comparator 72c. A forward-direction voltage Vf of the diode 72b is lower as the internal temperature To is higher.

Therefore, when the internal temperature To is lower than a set value, the forward-direction voltage Vf of the diode 72b is higher than a reference voltage Vr1 and an output voltage of the comparator 72c is High level. On the other hand, when the internal temperature To is higher than the set value, the forward-direction voltage Vf of the diode 72b is lower than the reference voltage Vr1 and the output voltage of the comparator 72c is Low level. Thus, the temperature detecting unit 72 changes a voltage to be output to the current setting unit 73 in accordance with whether the internal temperature To is higher or lower than the set value.

The current setting unit 73 includes MOSFETs 73a and 73e, resistances 73b and 73c, and an operational amplifier 73d. When the internal temperature To is lower than a set value, an output voltage of the comparator 72c is High level and the MOSFET 73a is on. Therefore, a current I1 of the current setting unit 73 is decided by a reference voltage Vr2, a resistance value R1 of the resistance 73c, and a resistance value R2 of the resistance 73b, and is indicated by “I1=Vr2/(R1//R2)”.

On the other hand, when the internal temperature To is higher than a set value, an output voltage of the comparator 72c is Low level, and the MOSFET 73a is off. Thus, the current I1 of the current setting unit 73 is decided by the reference voltage Vr2 and the resistance value R1 of the resistance 73c, and is indicated by “I1=Vr2/R1”, and thus decreases compared with a case where the internal temperature To is lower than the set value.

The delay unit 32 includes an inverter 32a, current sources 32b and 32e, switches 32c and 32d, a capacitor 32f, resistances 32g and 32h, and a comparator 32i. The current sources 32b and 32e and a drain of the MOSFET 73e of the current setting unit 73 are connected with one another by, for example, current mirror circuits (not illustrated), etc., and a current I2 of each of the current sources 32b and 32e is a current that is proportional to the current I1 of the current setting unit 73.

The PWM signal Sp is input to the switch 32c, and an inverted value of the PWM signal Sp is input, from the inverter 32a, to the switch 32d. When the PWM signal Sp turns from Low level into High level, the switch 32c is turned on and the switch 32d is turned off. Thus, the current I2 flows from the current source 32b into the capacitor 32f, and a voltage Vc (hereinafter, may be referred to as “capacitor voltage Vc”) of the capacitor 32f rises.

When the capacitor voltage Vc rises to exceed a predetermined voltage Vr3, a level of the delay PWM signal Spd output from the comparator 32i changes from Low level to High level. Let resistance values of the respective resistances 32g and 32h be “R3” and “R4”, and a voltage applied to a series circuit including the resistances 32g and 32h be “Vd”, the predetermined voltage Vr3 can be indicated by “Vr3=Vd×R4/(R3+R4)”.

Values of an electrostatic capacitance Cd of the capacitor 32f and the predetermined voltage Vr3 are fixed, and thus a voltage-rise rate of the capacitor voltage Vc is larger and the set time Td is shorter as the current I2 is larger. In other words, the current I2 and the set time Td are in a relation of inverse proportion.

The current I2 when the internal temperature To is higher than a set value is smaller than that when the internal temperature To is lower than the set value. Thus, the set time Td, which is an interval until when the capacitor voltage Vc rises to exceed the predetermined voltage Vr3, when the internal temperature To is higher than the set value is longer than that when the internal temperature To is lower than the set value.

Herein, let a relation between the current I1 and the current I2 be indicated by “I2=k1×I1+k2”. In this case, the set time Td, which is set by the delay unit 32, can be indicated by, for example, “Td=Cd×V/I2=Cd×V/(k1×I1+k2)”. Moreover, “k2” is a current value of each of current sources (not illustrated) that are connected in parallel with the respective current sources 32b and 32e, and “Cd” is a value of the electrostatic capacitance of the capacitor 32f. Each of “k1”, “k2”, and “V” is a constant value.

When the PWM signal Sp turns from High level into Low level, the switch 32c is turned off and the switch 32d is turned on. Thus, the current I2 flows into the current source 32e from the capacitor 32f, and thus the capacitor voltage Vc drops.

When the capacitor voltage Vc is lower than the predetermined voltage Vr3, a level of the delay PWM signal Spd output from the comparator 32i changes from High level into Low level. When resistance values R3 and R4 are appropriately set, a delay time of a change from Low level into High level can be set to be equal to that from High level into Low level.

Thus, when the internal temperature To is high, the light-source driving apparatus 1 illustrated in FIG. 9 sets the set time Td to be long, so that it is possible to shorten a minimum lighting time.

The change unit 35 illustrated in FIG. 10 changes, in accordance with the internal temperature To, the set time Td in two steps of long and short, however, is not limited thereto. For example, the change unit 35 may have a configuration that changes, in accordance with the internal temperature To, the current I1 in three or more steps so as to change the set time Td in three or more steps. The change unit 35 may have a configuration that continuously changes the current I1 so that the current I1 is smaller as the internal temperature To is higher, so as to continuously change the set time Td.

### 5. Fourth Configuration Example

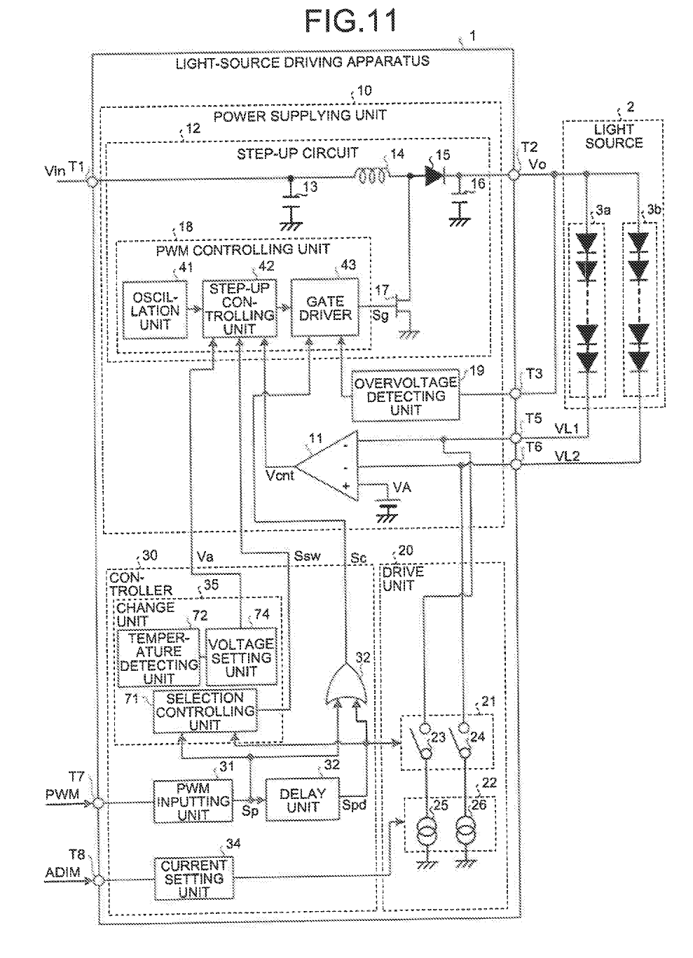

FIG. 11 is a diagram illustrating a fourth configuration example of the light-source driving apparatus 1 illustrated in FIG. 1A. The fourth configuration example of the light-source driving apparatus 1 differs from the third configuration example of the light-source driving apparatus 1 in that a rise rate of the output voltage Vo during the delay time TD, instead of a length of the set time Td (delay time TD), is changed in accordance with the internal temperature To. Hereinafter, points that differ from the third configuration example of the light-source driving apparatus 1 will be mainly explained, and explanation of other points will be appropriately omitted.

The controller 30 of the light-source driving apparatus 1 illustrated in FIG. 11 includes the change unit 35 that changes a rise rate of the output voltage Vo during the delay time TD in accordance with the internal temperature To. This change unit 35 changes a duty ratio of a PWM control during the delay time TD into the set duty ratio Ds according to the internal temperature To so as to change a rise rate of the output voltage Vo.

The change unit 35 includes the selection controlling unit 71, the temperature detecting unit 72, and a voltage setting unit 74. The temperature detecting unit 72 outputs a voltage according to the internal temperature To. The voltage setting unit 74 generates the control voltage Va according to a detection result of the internal temperature To obtained by the temperature detecting unit 72, and outputs this control voltage Va to the step-up controlling unit 42. The voltage setting unit 74 performs a logical multiplication computation on the PWM signal Sp and the delay PWM signal Spd so as to generate the selection signal Ssw that is High level during the delay time TD, and outputs this selection signal Ssw to the step-up controlling unit 42.

The step-up controlling unit 42 changes a control voltage to be used during the delay time TD on the basis of the selection signal Ssw from the control voltage Vcnt into the control voltage Va, and generates the PWM signal Sg on the basis of this control voltage Va and the carrier-wave voltage Vosc. Thus, a duty ratio of the PWM signal Sg is set to be the set duty ratio Ds according to the internal temperature To during the delay time TD, and a step-up operation is performed with the constant duty ratio according to the internal temperature To.

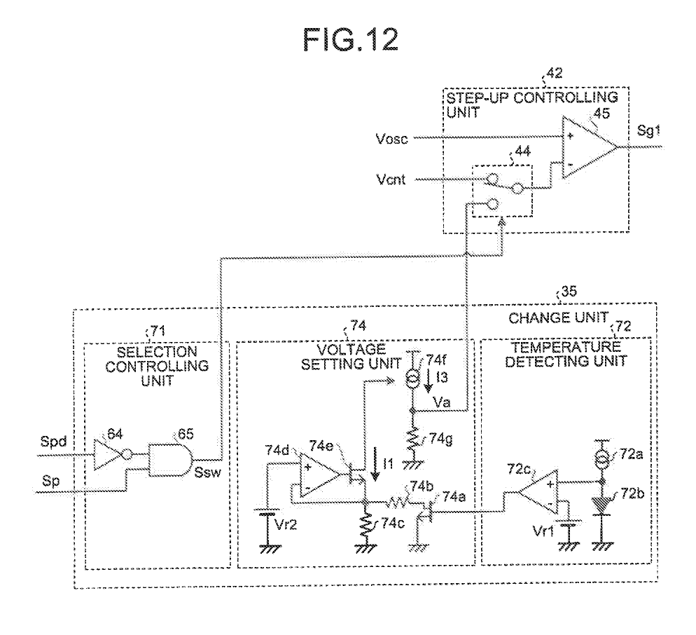

FIG. 12 is a diagram illustrating configuration examples of the temperature detecting unit 72, the voltage setting unit 74, the selection controlling unit 71, and the step-up controlling unit 42 of the light-source driving apparatus 1 illustrated in FIG. 11. The temperature detecting unit 72 illustrated in FIG. 12 has a configuration similar to that of the temperature detecting unit 72 illustrated in FIG. 10, and the step-up controlling unit 42 and the selection controlling unit 71 illustrated in FIG. 12 has respective configurations similar to those of the step-up controlling unit 42 and the selection controlling unit 71 illustrated in FIG. 6.

The voltage setting unit 74 includes MOSFETs 74a and 74e, resistances 74b and 74c, a comparator 74d, and a current source 74f. A circuit constituted of the MOSFETs 74a and 74e, the resistances 74b and 74c, and the comparator 74d is a circuit similar to that constituted of the MOSFETs 73a and 73e, the resistances 73b and 73c, and the operational amplifier 73d illustrated in FIG. 10, and changes a value of the current I1.

When the internal temperature To is lower than a set value, an output voltage of the comparator 74d is High level, and the current I1 of the voltage setting unit 74 is indicated by “I1=Vr2/(R1//R2)”. On the other hand, when the internal temperature To is higher than the set value, the output voltage of the comparator 74d is Low level, and the current I1 of the voltage setting unit 74 is indicated by “I1=Vr2/R1”. Therefore, when the internal temperature To turns high, the current I1 of the voltage setting unit 74 is turned small.

The current I1 of the voltage setting unit 74 adjusts a current I3 of the current source 74f. A drain of the MOSFET 74e and the current source 74f are connected with each other by, for example, a current mirror circuit (not illustrated), etc., and thus the current I3 of the current source 74f is a current that is proportional to the current I1. Therefore, when the internal temperature To turns high, the current I3 is turned small.

The current I3 flows into a resistance 74g, and thus a voltage of the resistance 74g is turned small when the current I3 turns small. The voltage of the resistance 74g is a voltage that is output to the step-up controlling unit 42 as the control voltage Va, when the internal temperature To turns high, the current I3 turns small and a voltage of the control voltage Va turns small.

When the selection signal Ssw is Low level, the step-up controlling unit 42 compares the control voltage Vcnt with the carrier-wave voltage Vosc to generate the PWM signal Sg1. On the other hand, when the selection signal Ssw is High level, the step-up controlling unit 42 compares the control voltage Va with the carrier-wave voltage Vosc to generate the PWM signal Sg1.

As described above, when the internal temperature To turns high, a voltage of the control voltage Va turns low, and thus when the internal temperature To turns high, the set duty ratio Ds turns large so that it is possible to shorten a minimum lighting time.

The change unit 35 illustrated in FIG. 12 changes the set duty ratio Ds in accordance with the internal temperature To in two steps of first and second fixed values, however, is not limited thereto. For example, the change unit 35 may have a configuration that changes the set duty ratio Ds in accordance with the internal temperature To in three or more steps. The change unit 35 may have a configuration that continuously changes the set duty ratio Ds so that the set duty ratio Ds turns larger as the internal temperature To turns higher.

### 6. Fifth Configuration Example

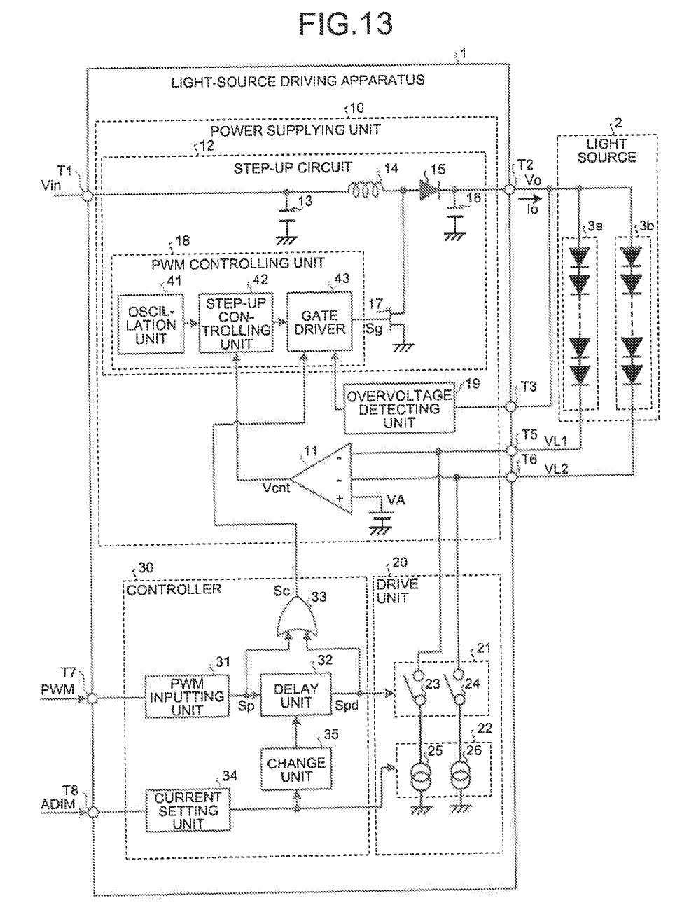

FIG. 13 is a diagram illustrating a fifth configuration example of the light-source driving apparatus 1 illustrated in FIG. 1A. The fifth configuration example of the light-source driving apparatus 1 differs from the first configuration example of the light-source driving apparatus 1 in that a length of the set time Td is changed in accordance with a value of a current flowing into the LED array 3 instead of the off time T_{OFF}. Hereinafter, points that differ from the first configuration example of the light-source driving apparatus 1 will be mainly explained, and explanation of other points will be appropriately omitted.

The controller 30 of the light-source driving apparatus 1 illustrated in FIG. 13 includes the change unit 35 that changes a length of the set time Td in accordance with a value of a current flowing into the LED array 3. This change unit 35 sets a length of the set time Td to be longer as a value of a current I_{LED} (hereinafter, may be referred to as “LED current I_{LED}”) flowing into the LED array 3 is larger.

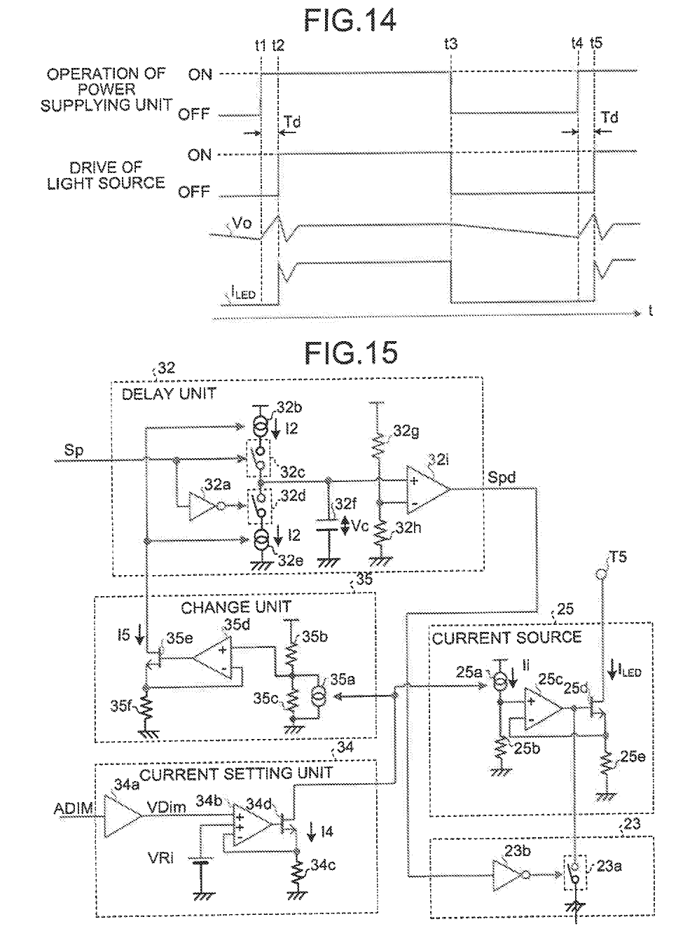

FIG. 14 is a diagram illustrating states of the output voltage Vo and the LED current I_{LED} (one example of driving current of light source) when a length of the set time Td is constant. As illustrated in FIG. 14, because a current Io (see FIG. 13) output from the power supplying unit 10 rapidly increases at each timing (time point t2 or t5) when the supply of the LED current I_{LED} to the LED array 3 is started, the output voltage Vo temporarily drops. Thus, as illustrated in FIG. 14, when the LED current I_{LED} temporarily drops, there exists a fear that a flicker occurs in the LED array 3.

Therefore, it is considered that the set time Td is extended so as to raise the output voltage Vo to a high voltage so that the occurrence of the flicker in the LED array 3 can be suppressed even when the current setting unit 34 sets the LED current I_{LED} to be maximum. In this case, there exists a fear that, when the current setting unit 34 sets the LED current I_{LED} to be minimum, the output voltage Vo excessively rises and the overvoltage detecting unit 19 detects an overvoltage, or a fluctuation in the output voltage Vo during a PWM period turns large and an abnormal noise caused by vibration of the capacitor 16 occurs.

On the other hand, because the light-source driving apparatus 1 illustrated in FIG. 13 sets a length of the set time Td to be longer as a value of the LED current I_{LED} is larger, an excessive rise in the output voltage Vo can be prevented even when the current setting unit 34 sets the LED current I_{LED} to be minimum. Therefore, for example, detection of an overvoltage by the overvoltage detecting unit 19 and occurrence of abnormal noise caused by the vibration of the capacitor 16 can be suppressed.

FIG. 15 is a diagram illustrating configuration examples of the switch 23, the current source 25, the delay unit 32, the current setting unit 34, and the change unit 35 of the light-source driving apparatus 1 illustrated in FIG. 13. However not illustrated, the switch 24 and the current source 26 have respective configurations similar to those of the switch 23 and the current source 25, and they are controlled similarly to the switch 23 and the current source 25.

As illustrated in FIG. 15, the current setting unit 34 includes amplifiers 34a and 34b, a resistance 34c, and a MOSFET 34d. The amplifier 34a generates a DC-dimming voltage VDim according to an ADIM controlling signal and outputs the DC-dimming voltage VDim to the amplifier 34b. The amplifier 34b outputs a voltage having a lower voltage of a reference voltage VRi and the DC-dimming voltage VDim.

An output from the amplifier 34b is input to a gate of the MOSFET 34d. A source of the MOSFET 34d is connected with the resistance 34c. Thus, when “VRi>VDim” is satisfied, a current I4 (hereinafter, may be referred to as “DC-dimming current I4”) flowing into the MOSFET 34d can be indicated by “I4=VDim/Ri”. “Ri” is a resistance value of the resistance 34c.

The current setting unit 34 outputs the DC-dimming current I4 having a value according to an ADIM controlling signal to the current source 25 and the change unit 35. When there exists no DC-dimming function (without amplifier 34a), the DC-dimming current I4 can be indicated by “I4=VRi/Ri”.

The current source 25 includes a current source 25a, resistances 25b and 25e, an amplifier 25c, and a MOSFET 25d. The current source 25a and a drain of the MOSFET 34d of the current setting unit 34 are connected with each other by a current mirror circuit, etc., and a current Ii from the current source 25a is a current that is proportional to the DC-dimming current I4. In other words, a value of the current Ii from the current source 25a is adjusted by an ADIM controlling signal.

A voltage of the resistance 25b is decided by the current Ii from the current source 25a, and this voltage of the resistance 25b is input to a gate of the MOSFET 25d from the amplifier 25c. The resistance 25e is connected with a source of the MOSFET 25d. Therefore, the LED current I_{LED} flowing into the LED array 3 caused by the MOSFET 25d can be indicated by “I_{LED}=Ii×R5/R6”.

“R5” is a resistance value of the resistance 25b, and “R6” is a resistance value of the resistance 25e. As described above, because a value of the current Ii corresponds to the DC-dimming current I4, a value of the LED current I_{LED} can be adjusted by an ADIM controlling signal.

The switch 23 includes a switching unit 23a (for example, MOSFET) and an inverter 23b. When the delay PWM signal Spd is High level, the inverter 23b outputs a signal of Low level to the switching unit 23a so as to turn the switching unit 23a off. In this case, the LED current I_{LED} is supplied to the LED array 3a.

On the other hand, when the delay PWM signal Spd is Low level, the inverter 23b outputs a signal of High level to the switching unit 23a so as to turn the switching unit 23a on. Thus, an output of the amplifier 25c is connected with the ground through the switching unit 23a to turn the MOSFET 25d off, and thus the supply of the LED current I_{LED} to the LED array 3a is stopped.

The delay unit 32 generates the delay PWM signal Spd obtained by delaying the PWM signal Sp by the set time Td, and outputs this delay PWM signal Spd to the switch 23. A configuration of this delay unit 32 is similar to that of the delay unit 32 illustrated in FIG. 10.

The change unit 35 connects the current setting unit 34 and the delay unit 32 therebetween. This change unit 35 includes a current source 35a, resistances 35b, 35c, and 35f, an operational amplifier 35d, and a MOSFET 35e.

The current source 35a is connected with a drain of the MOSFET 34d of the current setting unit 34 by a current mirror circuit, etc., and a current that is proportional to the DC-dimming current I4 flows into the current source 35a. The resistances 35b and 35c are serially connected with each other, and the current source 35a is connected in parallel with the resistance 35c on a downstream side. Therefore, a voltage of the resistance 35c turns smaller as a current flowing into the current source 35a turns larger.

The operational amplifier 35d outputs a voltage to the MOSFET 35e so that a voltage of the resistance 35f accords with that of the resistance 35c. Therefore, a value of a current I5 flowing into the MOSFET 35e turns smaller as a current flowing into the current source 35a turns larger.

A drain of the MOSFET 35e is connected with the current sources 32b and 32e of the delay unit 32 by, for example, current mirror circuits, etc., and the current I2 of each of the current sources 32b and 32e is a current that is proportional to the current I5 of the change unit 35. Therefore, when the DC-dimming current I4 increases, the current I2 of each of the current sources 32b and 32e decreases, and the set time Td is extended. The DC-dimming current I4 is a current that is proportional to the LED current I_{LED}, and thus the set time Td turns longer as the LED current I_{LED} turns larger and the set time Td turns shorter as the LED current I_{LED} turns smaller.

FIG. 16A is a diagram illustrating a relation, of the current setting unit 34 illustrated in FIG. 13, between the PWM signals Sp and Sg, the output voltage Vo, and the delay PWM signal Spd when the LED current I_{LED} is set to be minimum. FIG. 16B is a diagram illustrating the relation, of the current setting unit 34 illustrated in FIG. 13, between the PWM signals Sp and Sg, the output voltage Vo, and the delay PWM signal Spd when the LED current I_{LED} is set to be maximum. The PWM signal Sg illustrated in FIGS. 16A and 16B indicates a state as to whether or not the gate driver 43 outputs the PWM signal Sg, and a change in a duty ratio thereof is not illustrated.

As illustrated in FIG. 16A, when the current setting unit 34 sets the LED current I_{LED} to be minimum, the change unit 35 sets the set time Td to be short. Thus, an excessive rise in the output voltage Vo can be prevented, and thus, for example, detection of an overvoltage or occurrence of abnormal noise caused by the vibration of the capacitor 16 can be suppressed.

On the other hand, as illustrated in FIG. 16B, when the current setting unit 34 sets the LED current I_{LED} to be maximum, the change unit 35 sets the set time Td to be long. Therefore, the output voltage Vo can be raised to a high voltage so that the occurrence of the flicker in the LED array 3 can be suppressed.

The power supplying unit 10 can stop, for example, a feedback control using the control voltage Vcnt during the delay time TD and can keep a duty ratio of the PWM signal Sg constant, and thus the output voltage Vo can be raised to a high voltage.

Thus, the light-source driving apparatus 1 illustrated in FIG. 13 sets the set time Td to be shorter as the LED current I_{LED} to the LED array 3 is smaller, and even when the current setting unit 34 sets the LED current I_{LED} to be minimum, an excessive rise in the output voltage Vo can be prevented. Therefore, for example, detection of an overvoltage by the overvoltage detecting unit 19 or occurrence of abnormal noise caused by the vibration of the capacitor 16 can be suppressed.

It is sufficient that the controller 30 has a configuration that can set the set time Td to be shorter as the LED current I_{LED} to the LED array 3 is smaller, and a configuration of the controller 30 is not limited to that illustrated in FIG. 15. For example, the controller 30 may have a configuration that can change, in response to a change in the LED current I_{LED} to the LED array 3, the set time Td, not continuously, but in steps (for example, two steps or three or more steps).

The light-source driving apparatus 1 illustrated in FIG. 13 includes two pieces of the LED array 3 in the light source 2, and is controlled so that the LED currents I_{LED} that are similar to each other flow into the respective pieces of the LED array 3. Thus, it can be said that the change unit 35 of the light-source driving apparatus 1 illustrated in FIG. 13 changes the set time Td in accordance with a current flowing into the light source 2, and controls to set the set time Td to be longer as a value of the current flowing into the light source 2 is larger.

### 7. Sixth Configuration Example

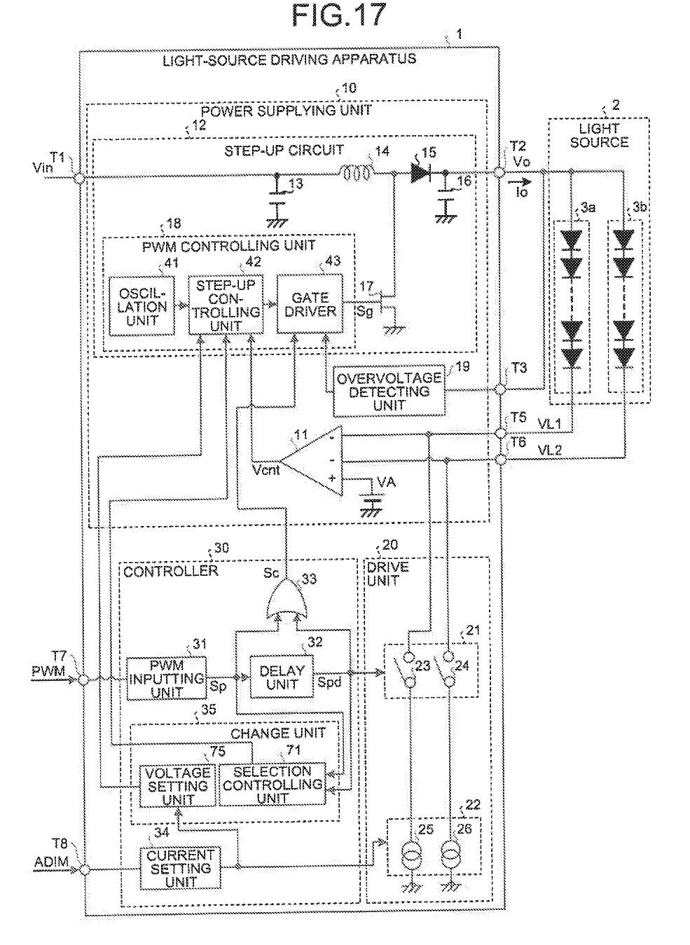

FIG. 17 is a diagram illustrating a sixth configuration example of the light-source driving apparatus 1 illustrated in FIG. 1A. The sixth configuration example of the light-source driving apparatus 1 differs from the fifth configuration example of the light-source driving apparatus 1 in that a rise rate of the output voltage Vo during the delay time TD, instead of a length of the set time Td (delay time TD), is changed. Hereinafter, points that differ from the fifth configuration example of the light-source driving apparatus 1 will be mainly explained, and explanation of other points will be appropriately omitted.

The controller 30 of the light-source driving apparatus 1 illustrated in FIG. 17 includes the change unit 35 that changes a rise rate of the output voltage Vo during the delay time TD in accordance with a value of the LED current I_{LED}. This change unit 35 changes a duty ratio of a PWM control during the delay time TD into the set duty ratio Ds according to a value of the LED current I_{LED} so as to change a rise rate of the output voltage Vo.

The change unit 35 includes a voltage setting unit 75 and the selection controlling unit 71. The voltage setting unit 75 generates the control voltage Va according to a value of the LED current I_{LED}, and outputs this control voltage Va to the step-up controlling unit 42. The selection controlling unit 71 performs a logical multiplication computation on the PWM signal Sp and the delay PWM signal Spd so as to generate the selection signal Ssw that is High level during the delay time TD, and outputs this selection signal Ssw to the step-up controlling unit 42.

The step-up controlling unit 42 changes, on the basis of the selection signal Ssw, a control voltage to be used during the delay time TD from the control voltage Vcnt into the control voltage Va, and generates the PWM signal Sg on the basis of this control voltage Va and the carrier-wave voltage Vosc. Thus, a duty ratio of a PWM control during the delay time TD turns into the set duty ratio Ds according to a value of the LED current I_{LED}, and a step-up operation is performed with this set duty ratio Ds.

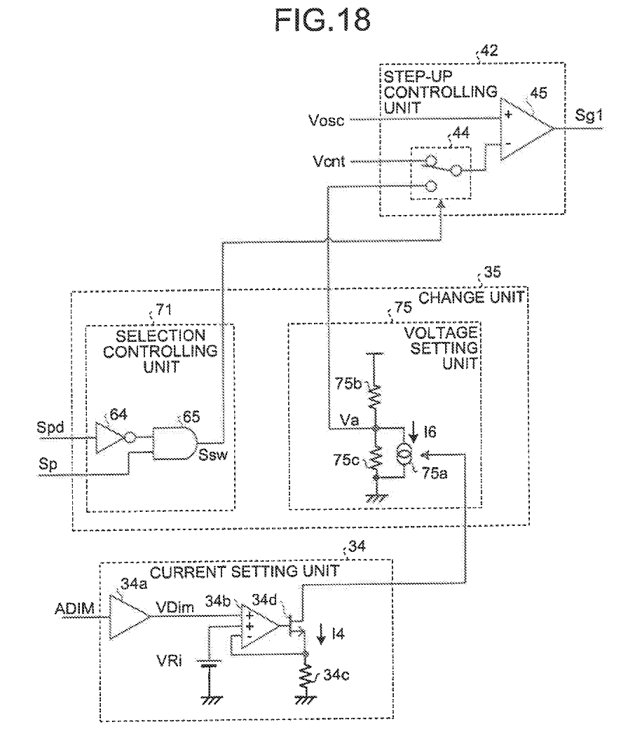

FIG. 18 is a diagram illustrating configuration examples of the current setting unit 34, the voltage setting unit 75, the selection controlling unit 71, and the step-up controlling unit 42 of the light-source driving apparatus 1 illustrated in FIG. 17. The current setting unit 34 illustrated in FIG. 18 has a configuration similar to that of the current setting unit 34 illustrated in FIG. 15, and the step-up controlling unit 42 illustrated in FIG. 18 has a configuration similar to that of the step-up controlling unit 42 illustrated in FIG. 6. The selection controlling unit 71 illustrated in FIG. 18 has a configuration similar to that of the selection controlling unit 71 illustrated in FIG. 6, and outputs the selection signal Ssw that is High level during the delay time TD.

The voltage setting unit 75 includes a current source 75a and resistances 75b and 75c. The current source 75a is connected with a drain of the MOSFET 34d of the current setting unit 34 by, for example, a current mirror circuit (not illustrated), etc., and a current that is proportional to the DC-dimming current I4 flows into the current source 75a. The resistances 75b and 75c are serially connected with each other, and the current source 75a is connected in parallel with the resistance 75c on a downstream side. Thus, a voltage of the resistance 75c is lower as a current I6 flowing into the current source 75a is larger.

The voltage of the resistance 75c is input, as the control voltage Va, to the selection switch 44 of the step-up controlling unit 42 from the voltage setting unit 75. A switch of the selection switch 44 is controlled by the selection signal Ssw, and the control voltage Va is output to the comparator 45 during the delay time TD.

Thus, the comparator 45 generates the PWM signal Sg1 during the delay time TD on the basis of a comparison between the carrier-wave voltage Vosc and the control voltage Va. The control voltage Va turns smaller as the DC-dimming current I4 turns larger, and thus the set duty ratio Ds turns larger as the DC-dimming current I4 turns larger.

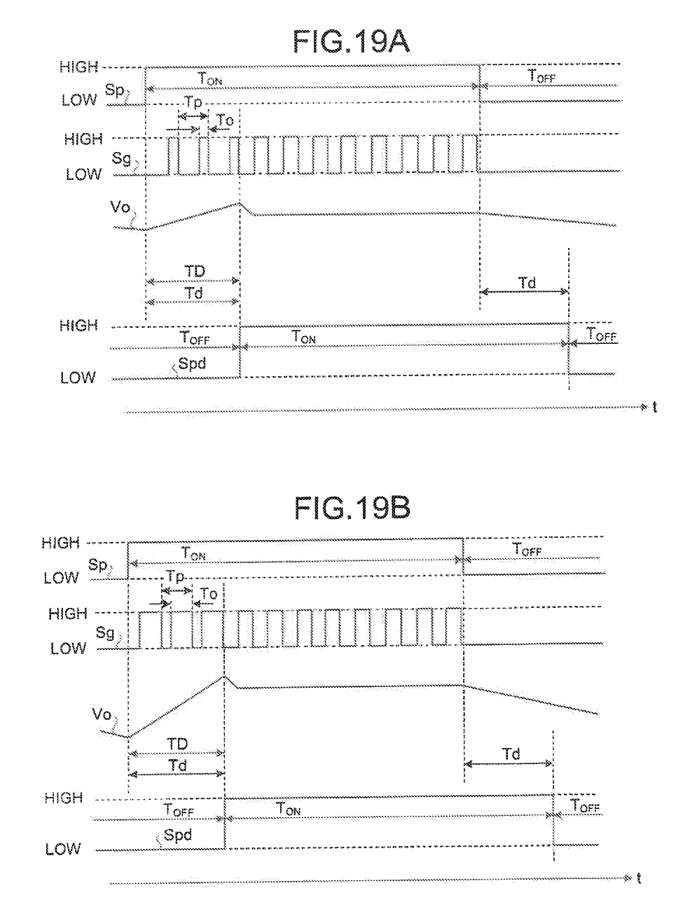

FIG. 19A is a diagram illustrating a relation, of the current setting unit 34 illustrated in FIG. 18, between the PWM signals Sp and Sg, the output voltage Vo, and the delay PWM signal Spd when the LED current I_{LED} is set to be minimum. FIG. 19B is a diagram illustrating the relation, of the current setting unit 34 illustrated in FIG. 18, between the PWM signals Sp and Sg, the output voltage Vo, and the delay PWM signal Spd when the LED current I_{LED} is set to be maximum.

As illustrated in FIG. 19A, when the current setting unit 34 sets the LED current I_{LED} to be minimum, the change unit 35 sets the set duty ratio Ds to be small. Thus, an excessive rise in the output voltage Vo can be prevented, and, for example, detection of an overvoltage or occurrence of abnormal noise caused by the vibration of the capacitor 16 can be suppressed.

On the other hand, as illustrated in FIG. 19B, when the current setting unit 34 sets the LED current I_{LED} to be maximum, the change unit 35 sets the set duty ratio Ds to be large. Thus, the output voltage Vo can be raised to a high voltage so that the occurrence of the flicker in the LED array 3 can be suppressed.

It is sufficient that the controller 30 has a configuration that can set the set duty ratio Ds to be shorter as the LED current I_{LED} to the LED array 3 is smaller, and thus a configuration of the controller 30 is not limited to that illustrated in FIG. 18. For example, the controller 30 may have a configuration that can change, in response to a change in the LED current I_{LED} to the LED array 3, the set duty ratio Ds, not continuously, but in steps (for example, two steps or three or more steps).

The light-source driving apparatus 1 illustrated in FIG. 17 includes two pieces of the LED array 3 in the light source 2, and is controlled so that the LED currents I_{LED} that are similar to each other flow into the respective pieces of the LED array 3. Thus, it can be said that the change unit 35 of the light-source driving apparatus 1 illustrated in FIG. 17 changes the set duty ratio Ds in accordance with a current flowing into the light source 2, and controls to set the set duty ratio Ds to be larger as a the current flowing into the light source 2 is larger.

### 8. Seventh Configuration Example

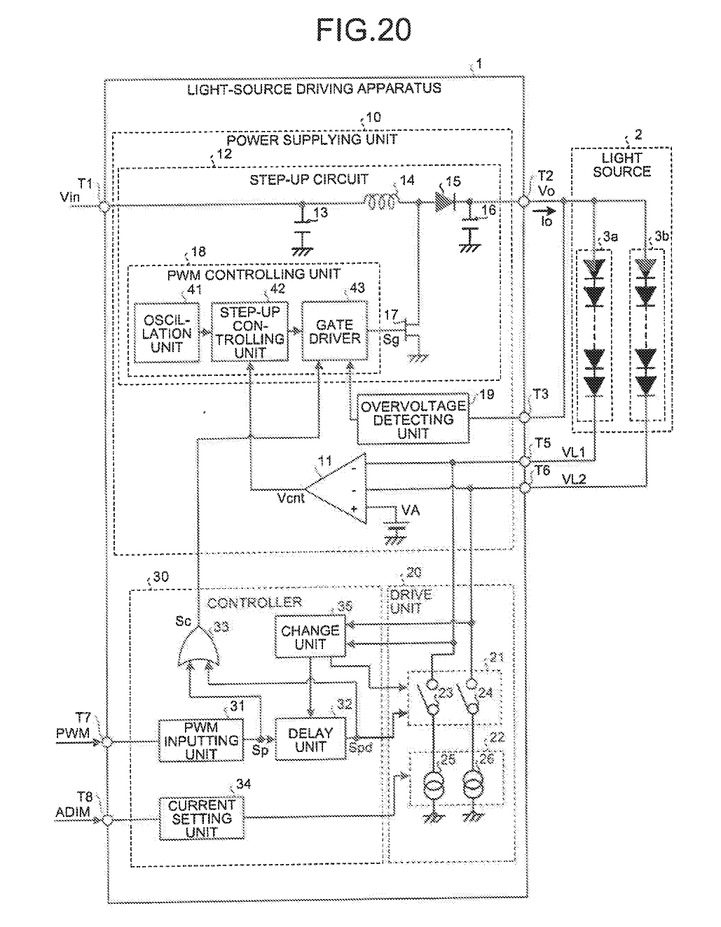

FIG. 20 is a diagram illustrating a seventh configuration example of the light-source driving apparatus 1 illustrated in FIG. 1A. The seventh configuration example of the light-source driving apparatus 1 differs from the fifth configuration example of the light-source driving apparatus 1 in that a length of the set time Td is changed in accordance with, instead of a value of the LED current I_{LED}, the number of pieces of the LED array 3 to be driven. Hereinafter, points that differ from the fifth configuration example of the light-source driving apparatus 1 will be mainly explained, and explanation of other points will be appropriately omitted.

The controller 30 of the light-source driving apparatus 1 illustrated in FIG. 20 includes the change unit 35 that changes a length of the set time Td in accordance with the number (hereinafter, may be referred to as “number of driven LEDs”) of pieces of the LED array 3 to be driven. This change unit 35 sets a length of the set time Td longer as the number of driven LEDs is larger.

When only one piece of the LED array 3 is connected with the light-source driving apparatus 1, the number of driven LEDs is one. Even in a case where two pieces of the LED array 3 are connected with the light-source driving apparatus 1, when a short-circuit failure or an open failure occurs in one of the pieces of the LED array 3, the number of driven LEDs is one.

A value of the current Io in a case where the number of driven LEDs is maximum (two), which is to be output from the power supplying unit 10 at a timing when the supply of the LED current I_{LED} to the LED array 3 is started, is larger than that in a case where the number of driven LEDs is one. Therefore, it is assumed that the set time Td is extended to raise the output voltage Vo to a high voltage so that the occurrence of the flicker in the LED array 3 can be suppressed even when the number of driven LEDs is maximum (two).

In this case, in a case where a length of the set time Td is constant regardless of the number of driven LEDs, there exists a fear that, when the number of driven LEDs is set to be minimum (one), the output voltage Vo excessively rises so that the overvoltage detecting unit 19 detects an overvoltage, or fluctuation in a PWM period of the output voltage Vo becomes large so that an abnormal noise caused by the vibration of the capacitor 16 occurs.

The light-source driving apparatus 1 illustrated in FIG. 20 sets a length of the set time Td to be longer as the number of driven LEDs is larger so as to raise the output voltage Vo to a high voltage. Thus, an excessive rise in the output voltage Vo can be prevented even when the number of driven LEDs of the current setting unit 34 is one, and, for example, detection of an overvoltage by the overvoltage detecting unit 19 and occurrence of abnormal noise caused by the vibration of the capacitor 16 can be suppressed.

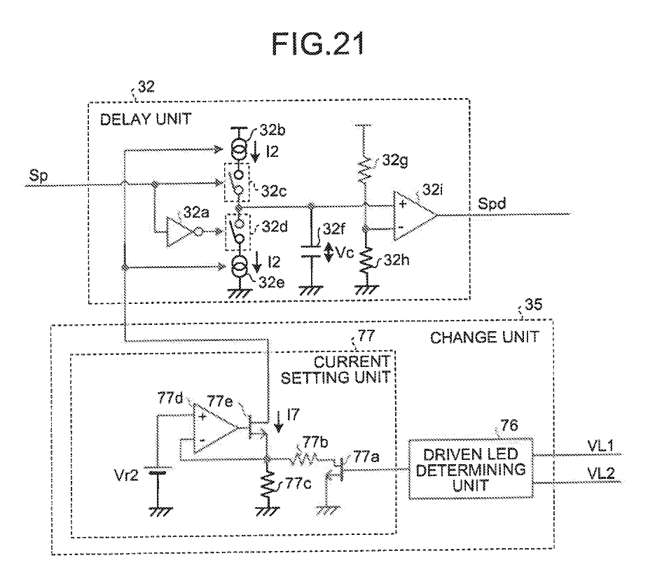

FIG. 21 is a diagram illustrating configuration examples of the change unit 35 and the delay unit 32 illustrated in FIG. 20. The delay unit 32 illustrated in FIG. 21 has a configuration similar to that of the delay unit 32 illustrated in FIG. 10. The change unit 35 includes a driven LED determining unit 76 and a current setting unit 77. The current setting unit 77 illustrated in FIG. 21 has a circuit configuration similar to that of the current setting unit 73 illustrated in FIG. 10.

The driven LED determining unit 76 determines, as non-driven LED arrays, the LED array 3 not connected with the light-source driving apparatus 1, the LED array 3 having a short-circuit failure, and the LED array 3 having an open failure on the basis of, for example, voltages VL1 and VL2. When there exists no non-driven LED array, the driven LED determining unit 76 determines that the number of driven LEDs is two, when there exists one non-driven LED array, the driven LED determining unit 76 determines that the number of driven LEDs is one, and when there exist two non-driven LED arrays, the driven LED determining unit 76 determines that the number of driven LEDs zero.

The driven LED determining unit 76 consistently turns off one or more switches corresponding to the non-driven LED array of the switches 23 and 24. Thus, for example, the supply of the LED current I_{LED} to a non-driven LED array having a failure can be prevented.

When determining that the number of driven LEDs is one or less, the driven LED determining unit 76 outputs a voltage of High level to the current setting unit 77, when determining that the number of driven LEDs is two, the driven LED determining unit 76 outputs a voltage of Low level to the current setting unit 77. The driven LED determining unit 76 may have a configuration that detects a non-driven LED array on the basis of, instead of the voltages VL1 and VL2, a current flowing between the LED array 3a and the drive unit 20 and a current flowing between the LED array 3b and the drive unit 20.

When a voltage of Low level is output from the driven LED determining unit 76, the current setting unit 77 sets a current I7 to be a relatively small current, when a voltage of High level is output from the driven LED determining unit 76, the current setting unit 77 sets the current I7 to be a relatively large current. Therefore, the current I7 when the number of driven LEDs is two is smaller than that when the number of driven LEDs is one or less.

A drain of a MOSFET 77e of the current setting unit 77 and the current sources 32b and 32e are connected one another by, for example, current mirror circuits (not illustrated), and the current I2 of each of the current sources 32b and 32e is a current that is proportional to the current I7 of the current setting unit 77.

As described above, in the delay unit 32, the current I2 and the set time Td are in a relation of inverse proportion, and thus the current I2 is smaller and the set time Td is longer, when the number of driven LEDs is two, than those in a case when the number of driven LEDs is one. Thus, a fluctuation in the output voltage Vo during a PWM period can be suppressed, and thus, for example, an abnormal noise caused by a vibration of the capacitor 16 can be prevented.

In the aforementioned example, the example is explained in which the light-source driving apparatus 1 can drive up to two pieces of the LED array 3, however, in a case where the light-source driving apparatus 1 can drive up to three or more pieces of the LED array 3, the change unit 35 may have a configuration that sets a length of the set time Td longer as the number of driven LEDs is larger.

In this case, for example, two or more combinations of respective MOSFETs 77a and resistances 77b are configured to be connected with a resistance 77c so that a resistance value between a source of the MOSFET 77e and the ground can be dropped by three or more steps. The driven LED determining unit 76 changes the MOSFET 77a to be turned on in accordance with the number of driven LEDs to change a value of the current I7.

### 9. Eighth Configuration Example

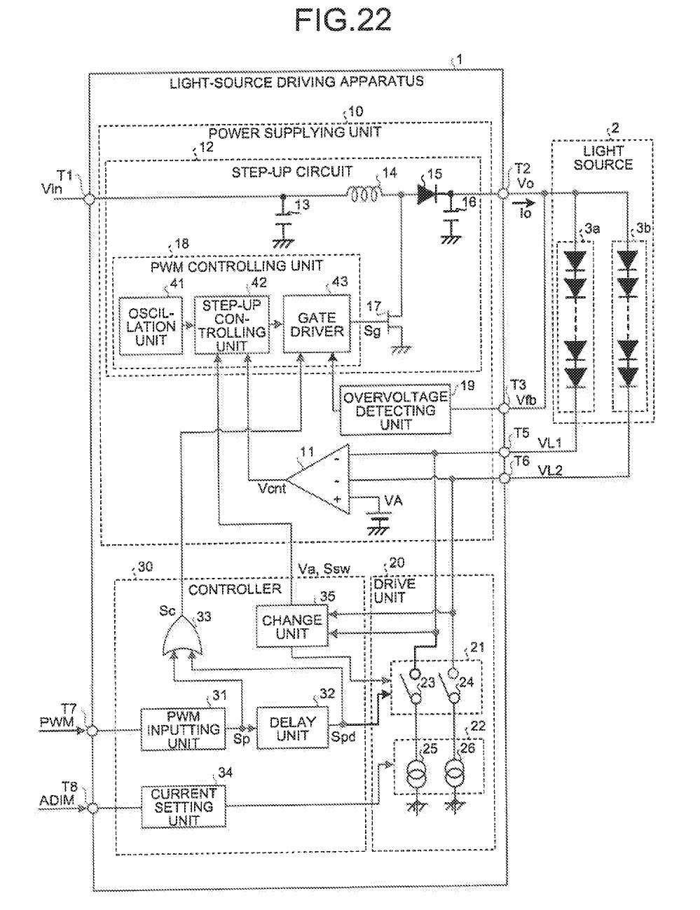

FIG. 22 is a diagram illustrating an eighth configuration example of the light-source driving apparatus 1 illustrated in FIG. 1A. The eighth configuration example of the light-source driving apparatus 1 differs from the seventh configuration example of the light-source driving apparatus 1 in that a rise rate of the output voltage Vo during the delay time TD, instead of a length of the set time Td (delay time TD), is changed. Hereinafter, points that differ from the seventh configuration example of the light-source driving apparatus 1 will be mainly explained, and explanation of other points will be appropriately omitted.

The controller 30 of the light-source driving apparatus 1 illustrated in FIG. 22 includes the change unit 35 that changes a rise rate of the output voltage Vo during the delay time TD in accordance with the number of driven LEDs. This change unit 35 changes a duty ratio of a PWM control during the delay time TD into the set duty ratio Ds according to the number of driven LEDs so as to change a rise rate of the output voltage Vo.

For example, the change unit 35 sets a rise rate of the output voltage Vo to be smaller as the number of driven LEDs is smaller. Thus, even when the number of driven LEDs of the current setting unit 34 is one, an excessive rise in the output voltage Vo can be prevented, and, for example, detection of an overvoltage by the overvoltage detecting unit 19 and occurrence of abnormal noise caused by the vibration of the capacitor 16 can be suppressed.

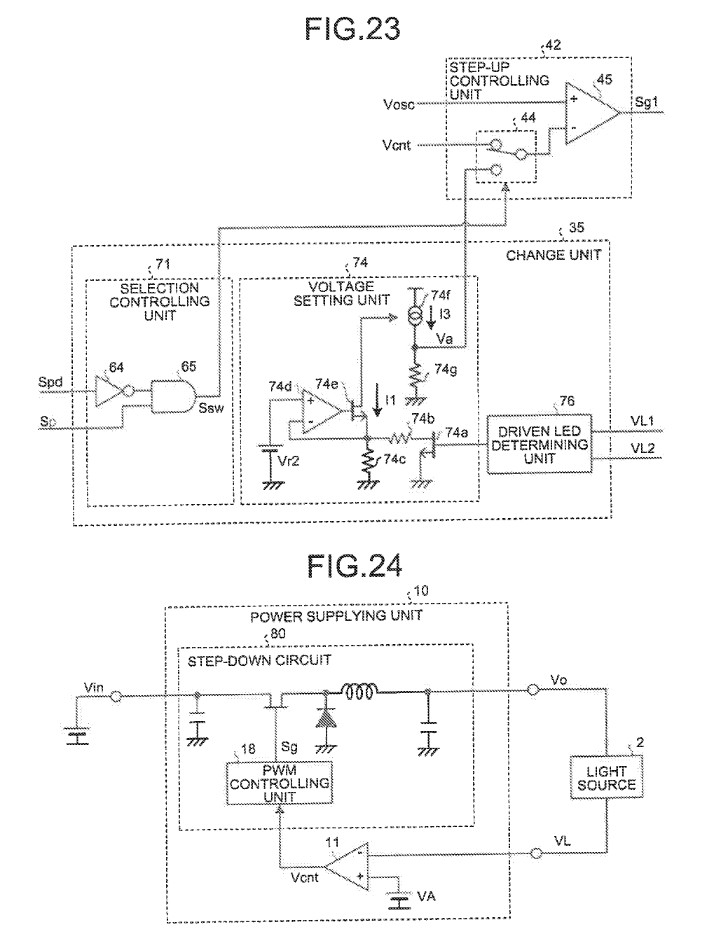

FIG. 23 is a diagram illustrating configuration examples of the change unit 35 and the step-up controlling unit 42 illustrated in FIG. 22. As illustrated in FIG. 23, the change unit 35 includes the selection controlling unit 71, the voltage setting unit 74, and the driven LED determining unit 76. The selection controlling unit 71 illustrated in FIG. 23 has a configuration similar to that of the selection controlling unit 71 illustrated in FIG. 6, and outputs the selection signal Ssw that is High level during the delay time TD. The voltage setting unit 74 illustrated in FIG. 23 has a configuration similar to that of the voltage setting unit 74 illustrated in FIG. 12.

When the number of driven LEDs is one or less, the driven LED determining unit 76 outputs a voltage of High level so as to increase the current I1 and the current I3, and thus the control voltage Va output from the voltage setting unit 74 is turned high. Thus, the set duty ratio Ds of the PWM signal Sg1 to be output from the PWM controlling unit 18 is turned small, and thus an excessive rise in the output voltage Vo can be prevented, and, for example, detection of an overvoltage and occurrence of abnormal noise caused by the vibration of the capacitor 16 can be suppressed.

On the other hand, when the number of driven LEDs is two, the driven LED determining unit 76 outputs a voltage of Low level, and thus the current I1 and the current I3 are turned small and the control voltage Va to be output from the voltage setting unit 74 is turned low. Thus, the set duty ratio Ds of the PWM signal Sg1 to be output from the PWM controlling unit 18 is turned large so that the output voltage Vo can be raised to a high voltage, and thus the occurrence of the flicker in the LED array 3 can be suppressed.

In the aforementioned example, the example is explained in which the light-source driving apparatus 1 can drive up to two pieces of the LED array 3, however, in a case where the light-source driving apparatus 1 can drive up to three or more pieces of the LED array 3, the change unit 35 may have a configuration that sets the set duty ratio Ds to be larger as the number of driven LEDs is larger.

In this case, for example, two or more combinations of respective the MOSFETs 74a and the resistance 74b are configured to be connected with the resistance 74c so that a resistance value between a source of the MOSFET 74e and the ground can be dropped by three or more steps. The driven LED determining unit 76 changes the MOSFET 74a to be turned on in accordance with the number of driven LEDs to change a value of the current I3.

### 10. Others

In the aforementioned embodiment, the eight configuration examples divided into the first to eighth configuration examples are explained, whereas any of the first to eighth configuration examples may be combined with each other. In other words, the change unit 35 may have a configuration that sets at least one of the set time Td and the set duty ratio Ds on the basis of at least two of the off time T_{OFF}, the internal temperature To, the LED current I_{LED}, and the number of driven LEDs.

For example, the change unit 35 may have a configuration that sets the set time Td to be longer as a length of the off time T_{OFF} is longer, sets the set time Td to be longer as the internal temperature To is higher, sets the set time Td to be longer as a value of the LED current I_{LED} is larger, and sets the set time Td to be longer as the number of driven LEDs is larger.

The change unit 35 may have a configuration that sets the set duty ratio Ds to be larger as a length of the off time T_{OFF} is longer, sets the set duty ratio Ds to be larger as the internal temperature To is higher, sets the set duty ratio Ds to be larger as a value of the LED current I_{LED} is larger, and sets the set duty ratio Ds to be larger as the number of driven LEDs is larger.

The change unit 35 may have a configuration that, for example, sets the set time Td to be longer as a length of the off time T_{OFF} is longer, sets the set time Td to be longer as the internal temperature To is higher, sets the set duty ratio Ds to be larger as a value of the LED current I_{LED} is larger, and sets the set duty ratio Ds to be larger as the number of driven LEDs is larger.

In the aforementioned first to eighth configuration examples, the case in which the step-up circuit 12 is provided in the power supplying unit 10 is exemplified, a configuration may be employed in which a step-down circuit, instead of the step-up circuit 12, is provided in the power supplying unit 10. FIG. 24 is a diagram illustrating a configuration example of the power supplying unit 10 provided with a step-down circuit 80 instead of the step-up circuit 12.

A step-down operation of the step-down circuit 80 generates the output voltage Vo, and the step-down circuit 80 changes on and off of the step-down operation and a control voltage during the delay time TD, caused by the control of the controller 30. In this case, the change unit 35 can set at least one of the set time Td and the set duty ratio Ds on the basis of at least one of the off time T_{OFF}, the internal temperature To, the LED current I_{LED}, and the number of driven LEDs.

In each of the aforementioned signals, mainly High level is set to be an active level. However, Low level may be set to be the active level. For example, an active level of the PWM signal Sp or the delay PWM signal Spd may be Low level.

The example is explained in which the aforementioned set duty ratio Ds is constant during the delay time TD. However, it is sufficient that the set duty ratio Ds is a control voltage independent from the control voltage Vcnt, and a duty ratio to be set in accordance with states of the one or more affecting factors.

For example, the change unit 35 may set the set duty ratio Ds to be larger as an elapsed time is longer, which is from a time point when the PWM signal Sp turns into High level from Low level. For example, the change unit 35 may set the set duty ratio Ds to be larger as an elapsed time is longer, which is from a time point when the PWM signal Sp turns into High level from Low level.

The aforementioned light-source driving apparatus 1 may be configured of, for example, an Application Specific Integrated Circuit (ASIC). The aforementioned light-source driving apparatus 1 may be used for a display apparatus such as a liquid-crystal display apparatus.

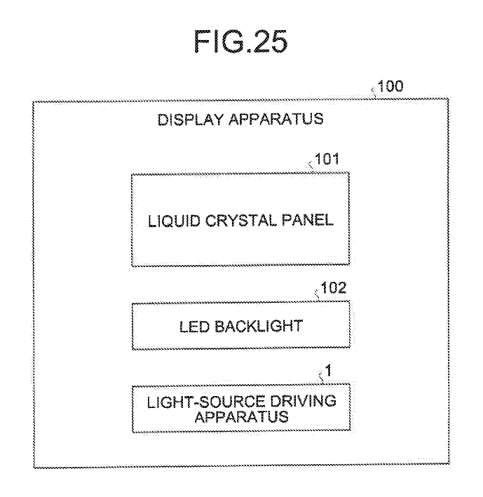

FIG. 25 is a diagram illustrating a display apparatus including the light-source driving apparatus 1 according to the embodiment. A display apparatus 100 illustrated in FIG. 25 includes a liquid crystal panel 101, an LED backlight 102, and the light-source driving apparatus 1. The LED backlight 102 includes, for example, a light guiding plate and the LED arrays 3a and 3b.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light-source driving apparatus comprising:
a power supplying unit that generates a voltage by a step-up operation or a step-down operation to output the voltage to one or more light sources;
a drive unit that drives the one or more light sources; and
a controller that causes the drive unit to drive the one or more light sources after a set time is elapsed from a start of the operation of the power supplying unit, wherein
the controller includes a change unit that changes a length of the set time and/or a rise rate of the voltage during the set time based on states of one or more factors that affect a drop in the voltage.

2. The light-source driving apparatus according to claim 1, wherein
the one or more factors that affect the drop in the voltage include at least one of a non-driven time of the one or more light sources, a temperature in the light-source driving apparatus, and a current flowing into the one or more light sources, and
the change unit changes the length of the set time and/or the rise rate of the voltage during the set time based on at least one of a length of the non-driven time of the one or more light sources, the temperature in the light-source driving apparatus, a value of the current flowing into the one or more light sources, and a number of the one or more light sources that are being driven.

3. The light-source driving apparatus according to claim 2, wherein, when the non-driven time of the one or more light sources is long, the change unit sets the length of the set time to be longer than the length of the set time when the non-driven time of the one or more light sources is short.

4. The light-source driving apparatus according to claim 2, wherein, when the non-driven time of the one or more light sources is long, the change unit sets the rise rate of the voltage during the set time to be larger than the rise rate when the non-driven time of the one or more light sources is short.

5. The light-source driving apparatus according to claim 2, wherein, when the temperature in the light-source driving apparatus is high, the change unit sets the length of the set time to be longer than the length of the set time when the temperature in the light-source driving apparatus is low.

6. The light-source driving apparatus according to claim 2, wherein, when the temperature in the light-source driving apparatus is high, the change unit sets the rise rate of the voltage during the set time to be larger than the rise rate when the temperature in the light-source driving apparatus is low.

7. The light-source driving apparatus according to claim 2, wherein, when the value of the current flowing into the one or more light sources is large, the change unit sets the length of the set time to be longer than the length of the set time when the current flowing into the one or more light sources is small.

8. The light-source driving apparatus according to claim 2, wherein, when the value of the current flowing into the one or more light sources is large, the change unit sets the rise rate of the voltage during the set time to be larger than the rise rate when the value of the current flowing into the one or more light sources is small.

9. The light-source driving apparatus according to claim 7, wherein,
the drive unit is able to drive a plurality of Light-Emitting-Diode (LED) arrays as the light sources, and
the change unit sets, when a number of the LED arrays driven by the drive unit is large, the length of the set time to be longer than the length of the set time when the number of the LED arrays driven by the drive unit is small.

10. The light-source driving apparatus according to claim 7, wherein,
the drive unit is able to drive a plurality of LED arrays as the light sources, and
the change unit sets, when a number of the LED arrays driven by the drive unit is large, the rise rate of the voltage during the set time larger than the rise rate when the number of the LED arrays driven by the drive unit is small.

11. The light-source driving apparatus according to claim 1, wherein
the factors that affect the drop in the voltage include a non-driven time of the one or more light sources, and
the change unit changes the length of the set time and/or the rise rate of the voltage during the set time based on a length of the non-driven time of the one or more light sources.

12. The light-source driving apparatus according to claim 1, wherein
the factors that affect the drop in the voltage include a temperature in the light-source driving apparatus, and
the change unit changes the length of the set time and/or the rise rate of the voltage during the set time based on the temperature in the light-source driving apparatus.

13. The light-source driving apparatus according to claim 1, wherein
the factors that affect the drop in the voltage include a current flowing into the one or more light sources, and
the change unit changes the length of the set time and/or the rise rate of the voltage during the set time based on a value of the current flowing into the one or more light sources.

14. A light-source driving method comprising:
generating a voltage by a step-up operation or a step-down operation of a power supplying unit to output the voltage to one or more light sources;
driving the one or more light sources after a set time is elapsed from a start of the operation of the power supplying unit; and
changing a length of the set time and/or a rise rate of the voltage during the set time based on states of one or more factors that affect a drop in the voltage.

15. The light-source driving method according to claim 14, wherein
the factors that affect the drop in the voltage include a non-driven time of the one or more light sources, and
the changing includes changing the length of the set time and/or the rise rate of the voltage during the set time based on a length of the non-driven time of the one or more light sources.

16. The light-source driving method according to claim 14, wherein
the factors that affect the drop in the voltage include a temperature in a light-source driving apparatus, and
the changing includes changing the length of the set time and/or the rise rate of the voltage during the set time based on the temperature in the light-source driving apparatus.

17. The light-source driving method according to claim 14, wherein
the factors that affect the drop in the voltage include a current flowing into the one or more light sources, and
the changing includes changing the length of the set time and/or the rise rate of the voltage during the set time based on a value of the current flowing into the one or more light sources.
